(19) United States
(12) Patent Application Publication
(10) Pub. No.: US 2026/0300063 A1
(43) Pub. Date: Oct. 1, 2026

(54) LOCAL HUB SYNCHRONIZATION SYSTEM

(71) Applicant: Block, Inc., Oakland, CA (US)

(72) Inventors: Logan Johnson, Brooklyn, NY (US); Mark Rohan, Fredericktown, MO (US)

(73) Assignee: Block, Inc., Oakland, CA (US)

(21) Appl. No.: 19/092,990

(22) Filed: Mar. 27, 2025

(51) Int. Cl. G06F 11/07; H04L 43/0811; H04L 67/1095

(52) U.S. Cl. CPC G06F 11/0709; H04L 43/0811; H04L 67/1095

(57) ABSTRACT

Local hub synchronization systems are described. In an example, communications are received from multiple edge devices, conflicts are detected, and intents are inferred from each communication. The system determines a conflict resolution module based on the inferred intents and executes the conflict resolution module to resolve the conflict. A resolved communication is then generated and used to update the local hub's database. The resolved communication is transmitted to the original edge devices to synchronize their local databases and to a service provider system to indicate the resolution of the conflict.

### TECHNICAL FIELD

A variety of techniques have been developed to support local device communication. Conventional techniques to do so, however, may become overwhelmed in high traffic scenarios involving a large amount of communications. In one or more examples, a merchant environment for a restaurant may include numerous point-of-sale devices, kiosks, kitchen-display systems, and so forth. Further, this merchant environment may support edits to a same item of data, such as a food and beverage order. This complexity is further increased by a number of these items of data that may be managed even in a single data. Consequently, these technical challenges may overwhelm conventional local device communication techniques, introduce errors, and result in inefficient use of computational and network resources.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is a block diagram depicting a non-limiting example of a system configured to implement a local hub synchronization system in accordance with one or more implementations.

FIG. 2A depicts a system in an example implementation showing operation of a local hub synchronization system of FIG. 1 in greater detail as facilitating communication management in accordance with one or more implementations.

FIG. 2B depicts an example implementation of a structural example of an audit log of FIG. 2A in greater detail in accordance with one or more implementations.

FIG. 2C depicts an example implementation of a JavaScript Object Notation (JSOM) example of an audit log of FIG. 2A in greater detail in accordance with one or more implementations.

FIG. 3 depicts a system in an example implementation showing operation of a local hub synchronization system of FIG. 1 in greater detail as updating communications in accordance with one or more implementations.

FIG. 4 depicts a system in an example implementation showing output of a user interface by a first edge device as entering items for an order.

FIG. 5 depicts a system in an example implementation showing output of a user interface by a second edge device as making a change to the items in an order.

FIG. 6 depicts a system in an example implementation showing output of a user interface by the first edge device as surfacing the update to the order.

FIG. 7 depicts a system in an example implementation showing operation of a local hub synchronization system of FIG. 1 in greater detail as engaging in conflict resolution in accordance with one or more implementations.

FIG. 8 depicts a system in an example implementation showing output of a user interface by a first edge device as entering items for an order.

FIG. 9 depicts a system in an example implementation showing output of a user interface by a second edge device as entering items for an order that conflict with the items in the order from the first edge device.

FIG. 10 depicts a system in an example implementation showing output of a user interface by the first edge device as surfacing an option to resolve the conflict by a human.

FIG. 11 is a flow diagram depicting an algorithm as a step-by-step procedure in an example implementation of operations performable for accomplishing a result of local hub synchronization and conflict resolution in one or more implementations.

FIG. 12 depicts a system that demonstrates how a remote hub synchronization system is usable to introduce edge devices to the functionality of a local hub synchronization system without involving actual implementation at a respective establishment in one or more implementations.

FIG. 13 illustrates a system showing initial implementation of a remote hub synchronization system, introduction of a local hub synchronization system, and use of the remote hub synchronization system as a fallback in one or more implementations.

FIG. 14A is a flow diagram depicting an algorithm as a step-by-step procedure in an example implementation of operations performable for accomplishing a result of remote and local hub synchronization and conflict resolution in one or more implementations.

FIG. 14B is a flow diagram depicting an algorithm as a step-by-step procedure in another example implementation of operations performable for accomplishing a result of remote and local hub synchronization and conflict resolution in one or more implementations.

FIG. 15 is a non-limiting example illustrating an environment in which recommendation techniques described herein are performed in accordance with one or more implementations.

FIG. 16 is a non-limiting example illustrating an environment in which recommendation techniques described herein are performed in accordance with one or more implementations.

FIG. 17 is a non-limiting example illustrating an environment in which recommendation techniques described herein are performed in accordance with one or more implementations.

### DETAILED DESCRIPTION

### Overview

In conventional multi-device computing architectures such as point-of-sale (POS) systems, maintaining synchronization between multiple edge devices at an establishment (e.g., a merchant location) and remote (e.g., “cloud-based”) services has been a significant technical challenge. “Edge” devices refer to computational devices typically arranged at an edge of a network architecture, e.g., provide user interfaces supporting human interaction. These conventional systems are typically configured in such a way that edge devices (e.g., POS terminals, kiosks, and kitchen display systems) communicate with each other via intermediary cloud-based services for propagating account status updates and other data. This conventional architecture can lead to increased network delays, potential inconsistencies across edge devices, and an undue reliance on consistent internet connectivity, which can further slow order updates, out-of-sync inventory management, and customer service inefficiencies. For example, in scenarios where internet connectivity is disrupted or offline, edge devices may struggle in a conventional architecture to maintain up-to-date information, potentially leading to data inconsistencies across devices and causing operational disruptions.

The complexity of managing real-time updates across multiple domains (such as account status, order management, and inventory) further compounds these challenges. Conventional systems may struggle in high concurrency issues where multiple edge devices transmit communications that attempt to modify a same data structure (e.g., data in a database, metadata associated with the data, format of the data as defined by a schema, and so forth) simultaneously. Additionally, conventional systems task each edge device with independently fetching and processing updates to this data. These technical challenges can impact system responsiveness, data consistency, overall reliability, and computational resource efficiency particularly in high-volume establishments (e.g., restaurants and retail environments) relying on rapid and accurate information exchange. This makes reliance solely on remote (e.g., cloud-based) services unsuitable for high-volume, real time environments, such as restaurants or retail stores, where split-second decisions are critical.

To this end, a local hub synchronization system is described herein that addresses these and other technical challenges associated with maintaining data consistency when edge devices communicate with each other and the remote (e.g., cloud-based) services by implementing local or on-premise synchronization to enable local communication between edge devices without reliance on the cloud intermediary. Communications between and from edge devices may involve transaction processing, order management, inventory management, customer engagement, receipts, computing device operation, invoices, and so forth. A restaurant establishment, for instance, may include numerous edge devices, examples of which include point-of-sale (POS) devices, kitchen display system (KDS) devices, digital menu boards, kiosk devices, printers, and so forth. The local hub synchronization system, as described herein, enables local (e.g., “on premise”) device-to-device communication and synchronization between edge devices without constant reliance on remote (e.g., cloud-based) services that are accessed via a network.

The local hub synchronization system, for instance, acts as a central node for locally managing real-time or near real-time communication updates across multiple domains, including account status, order management, and inventory. The local hub synchronization system is configurable to efficiently handle conflicts that may arise when multiple edge devices attempt to modify the same data simultaneously, or within a threshold time period of one another (e.g., less than one second, five seconds, etc.), via respective communications, utilizing a robust conflict resolution system.

In some implementations, the local hub synchronization system can be configured to dynamically implement conflict resolution modules to handle conflicting data received from multiple edge devices. These techniques, for instance, may rely on inferring an intent behind the communications in order to discern a “correct” course of action. Depending on the implementation, a context or an intent may be inferred by the local hub synchronization system from the communications and used to determine an optimal path towards conflict resolution.

A context describes environmental factors in which a communication occurs, e.g., time, location, device state, network conditions, user role, and historical interactions between users or between user and edge devices. The context is then usable to infer intent by extracting an intended purpose behind an action by analyzing a context defined using patterns, decision-making frameworks, and user behaviors to determine the desired outcome. The inferred intent is then used as a basis to resolve the conflict. Thus, conflict resolution involving detecting a context including which conditions exist when data conflicts occur and then resolving contention by prioritizing or arbitrating based on an intent inferred from the context. Thus, intent inference detects what particular action was intended and subsequent conflict resolution determines which conflict resolution module best aligns with a technical outcome that is aligned with that intent.

In some implementations, the local hub synchronization system executes a variety of techniques to infer intent behind a respective communication. In some implementations, the local hub synchronization system selectively applies one or a combination of the techniques depending on a context around edge devices, e.g., time of the day, nature of the seller items, etc. Examples of these techniques include timestamp-based resolution, where a more recent transaction takes precedence; priority-based resolution, where certain devices, instructions, or transaction types are given higher priority; merge-based resolution, which combines non-conflicting parts of transactions; heuristic or rule-based resolution, and so forth.

In an example, a communication from an edge device may specify removal of items from an order while another communication from another edge device, obtained simultaneously or in near-real time to the first communication, may specify additional items. Therefore, an intent that is inferred indicating that the orders exhibit that someone “changed their mind” will cause the local hub synchronization system to resolve the conflict by removing the first communication and implementing actions corresponding to the second communication.

In another example, if a first edge device submits a price change for an item while a second edge device simultaneously submits an inventory update for the same item, the local hub synchronization system may readily determine intent behind the change and the update. The local hub synchronization system may then apply a rule that allows both changes to coexist as the intents do not conflict and thereby update both the price and inventory. In cases where direct reconciliation is not possible, the local hub synchronization system may implement a queueing mechanism to process transactions sequentially (e.g., to resolve conflicts “as they occur” by implementing each change sequentially) or escalate the conflict to a secondary resolution mechanism manned by a human operator for manual resolution or through a secondary intent resolution process (e.g., a different technique than previously executed).

These diverse conflict resolution strategies enable the local hub synchronization system to maintain data consistency across each of the connected edge devices while adapting to various types of conflicts that may arise in a multi-device POS environment. These diverse conflict resolution strategies thus ensure data consistency across each of the connected edge devices and reduces a processing load on remote (e.g., cloud-based) services implemented by service provider systems by consolidating and managing updates to data structures involving the communications from edge devices locally before synchronizing with the remote (e.g., cloud based) services.

Additionally, the local hub synchronization system is configurable to implement a caching mechanism that allows edge devices to access up-to-date information even in scenarios of temporary internet outages. The local hub synchronization system, for instance, may detect a network outage and cache communications that are communicated locally at an establishment. Upon restoration of network operability, the local hub synchronization system may then transmit the cached communications to a remote (e.g., cloud-based) service. Enhanced reliability supported in this instance for both online and offline scenarios, combined with improved system responsiveness even in instances of network outages and supports use in high-volume seller, e.g., retail and restaurant environments, relying on rapid and accurate information exchange. The local hub synchronization system's architecture also provides a scalable foundation for integrating additional edge devices and digital services, offering flexibility for future expansions and adaptations.

In some implementations, a remote (e.g., cloud-based) system referred to as a “remote hub synchronization system” in the following discussion may be implemented along with the local hub synchronization system to manage communications between multiple edge devices at a merchant location and cloud-based services. The remote hub synchronization system, for instance, may serve as an initial way in which data may be synchronized across edge devices and to resolve conflicts. As merchants transition to a local hub synchronization system, the remote hub synchronization system may continue to operate in parallel, allowing for a gradual migration of functionality. This approach may enable merchants to maintain consistent operations while adapting to the new local hub infrastructure.

In some scenarios, the local hub synchronization system may become temporarily inaccessible due to hardware failures, network issues, or other unforeseen circumstances. During such instances, the edge devices may automatically fall back to use of the remote hub synchronization system. This fallback mechanism helps to ensure continuous operation and data synchronization even when the local hub is unavailable. Once the local hub synchronization system is restored, the edge devices may seamlessly transition back to using the local hub, potentially leveraging the remote hub synchronization system to reconcile data discrepancies that occurred during the outage. A variety of other examples are also contemplated, further discussion of which may be found in the following sections and shown in corresponding figures.

The local hub synchronization system enhances multi-device communication by enabling on-premises data synchronization between edge devices such as POS terminals, kiosks, and kitchen displays, reducing latency, cloud dependency, and network congestion. Unlike conventional cloud-based architectures that rely on constant internet connectivity, this system processes communications locally, allowing edge devices (e.g., POS terminals, kiosks, kitchen displays) to exchange data directly over a Wi-Fi or LAN network in scenarios that would cause conventional device architectures to fail due to reliance on network communication. By caching recent transactions, the local hub synchronization system ensures continued operation during internet outages, synchronizing updates with the cloud once connectivity is restored. Additionally, the local hub synchronization system is configurable to employ intelligent conflict resolution modules, including timestamp-based prioritization, priority-based overrides, and AI-driven intent analysis, to resolve data inconsistencies in real-time based on an intent that is inferred from a context of the communication.

These techniques support resource utilization optimization, enhance system reliability, and provide a scalable, low-latency synchronization model for high-traffic environments like retail and restaurants, where payment information is sensitive and central to operation of the environment. For example, in environments involving numerous financial transactions such as restaurants, retail stores, and so forth, reliability and scalability of the local hub synchronization system supports operation in which conventional techniques may fail, e.g., due to a lack of network accessibility. In the queuing techniques as supported by the local hub synchronization system, for instance, orders may continue at an establishment even in instances in which network operation has failed and may then continue with a remote system (e.g., to resolve transactions) once network operation is restored, which is not possible in conventional techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Local Hub Synchronization Environment

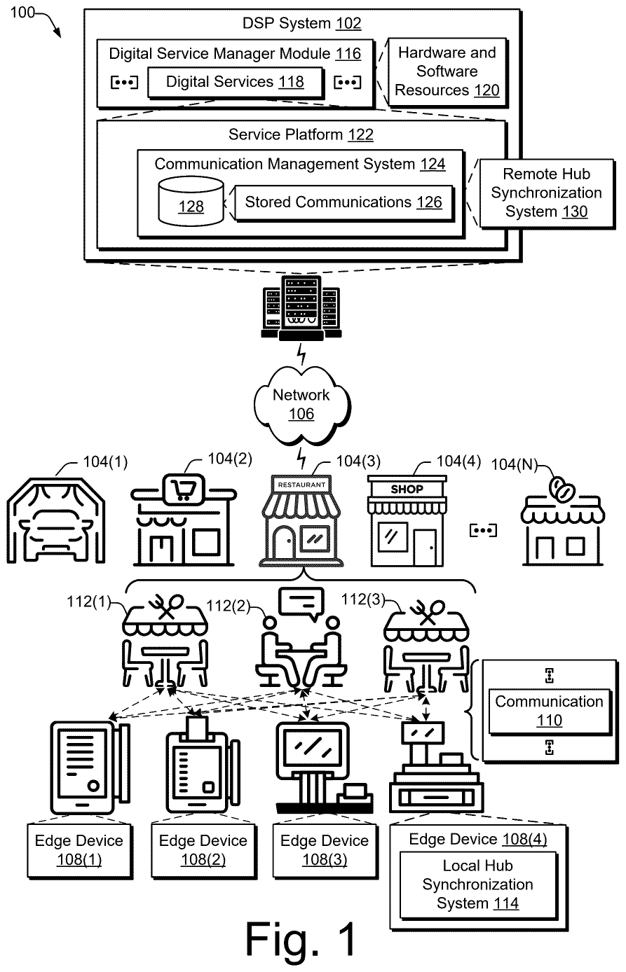

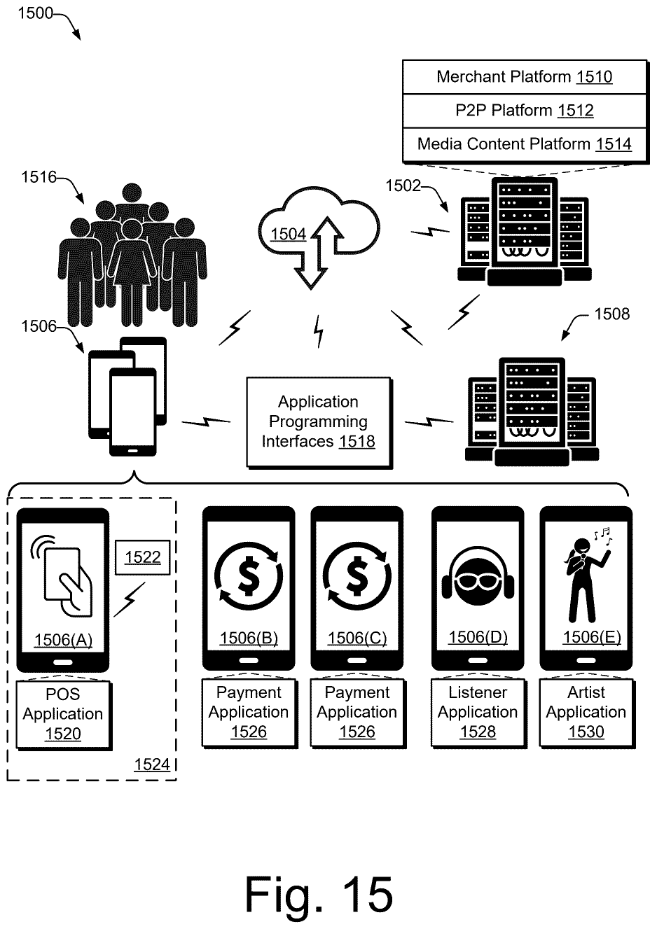

FIG. 1 is a block diagram depicting a non-limiting example of a multi-device environment, e.g., system 100, configured to implement a local hub synchronization system in accordance with one or more implementations. The system 100 includes a digital service provider (DSP) system (illustrated as a DSP system 102) as communicatively coupled with a plurality of establishments that are configured to provide one or more products or services, examples of which include a vehicle establishment 104(1), a retail establishment 104(2), a restaurant establishment 104(3), a merchant establishment 104(4), . . . , to a beverage establishment 104(N). One or more instances of these establishments may be referred to separately or collectively as establishment 104 in the following discussion. The vehicle establishment 104(1) (e.g., auto repair, carwash), a retail establishment 104(2) (e.g., supermarket), a restaurant establishment 104(3), a merchant establishment 104(4) (e.g., clothing store), . . . , to a beverage establishment 104(N) (e.g., coffee shop) are communicatively coupled to the DSP system 102 via a network 106, e.g., the internet. The various establishments 104 may be configured as merchants as further described in relation to FIGS. 15-17.

Each of the establishments 104 may employ a variety of edge devices 108(1), 108(2), 108(3), 108(4) that are configured to transmit and receive communications 110, which may take a variety of forms. In the illustrated example of a restaurant establishment 104(3), for instance, the communications 110 involve respective orders 112(1), 112(2), 112(3) associated with respective patrons of the establishment, depicted at respective tables within the restaurant establishment 104(3). A variety of parameters may be associated with each of the orders 112(1)-112(3). Examples of these parameters include specific item selection, quantity, customizations (e.g., cooking style such as rare, medium, well-done), ingredient modifications (e.g., extra cheese, no onions), side dishes, beverages with preferences (e.g., no ice, lemon in water), any allergies or dietary restrictions, desired sauces or condiments, serving preferences (e.g., separate plates, family-style), special instructions (e.g., no dairy), and so forth. Different types of parameters may be associated with different types of establishments, e.g., sizing for a merchant establishment 104(4) (e.g., a clothing retailer), type of vehicle for a vehicle establishment 104(1), and so forth. Thus, a communication 110 may be configured in a multitude of different ways to support orders of goods or services in this example.

As previously described, conventional techniques used to maintain synchronization between multiple edge devices at an establishment (e.g., a merchant location) encounter significant technical challenges. Conventional techniques, for instance, typically rely on of communication between each edge device with a cloud-based service as an intermediary for account status updates and other data even in instances when the devices are in physical proximity to each other. This conventional architecture may lead to increased latency, potential inconsistencies across edge devices, and an undue reliance on consistent internet connectivity. For example, in scenarios where Internet connectivity is unstable or unavailable, edge devices may struggle in conventional scenarios to maintain up-to-date information, potentially causing operational disruptions.

Additionally, the complexity of managing real-time updates across multiple domains (such as account status, order management, and inventory) further compounds these challenges. Therefore, conventional systems may struggle to efficiently handle conflicts that arise when multiple edge devices transmit communications that attempt to modify the same data. Additionally, conventional systems task each edge device with independently fetching and processing updates to this data. These technical challenges can impact system responsiveness, data consistency, overall reliability, and computational resource efficiency particularly in high-volume establishments (e.g., restaurants and retail environments) involving rapid and accurate information exchange.

Accordingly, to address these and other technical challenges a local hub synchronization system 114 is described that is configurable to maintain data consistency and reduce latency in multi-device environments. A restaurant establishment 104(3), for instance, may include numerous edge devices, examples of which include point-of-sale (POS) devices, kitchen display system (KDS) devices, digital menu boards, kiosk devices, printers, and so forth. By implementing a local hub synchronization system 114 at the restaurant establishment 104(3) in this example, the local hub synchronization system 114 enables local (e.g., “on premise” or “local” via Wi-Fi) device-to-device communication and synchronization without reliance on cloud-based services. This architecture significantly reduces network latency and minimizes the impact of unstable Internet connectivity and/or cloud system outages on business operations.

The local hub synchronization system 114, for instance, acts as a central node for managing real-time communication updates across multiple domains, including account status, order management, and inventory. The local hub synchronization system 114 is also configurable to efficiently handle conflicts that may arise when multiple edge devices attempt to modify the same data simultaneously and/or within a threshold amount of time of one another via respective communications, utilizing a robust conflict resolution system. Although illustrated as executed using software by a respective edge device (e.g., edge device 108(4)), the local hub synchronization system 114 is also configurable as implemented using a dedicated local hub synchronization device having a respective processing device and computer-readable storage media.

The local hub synchronization system 114 may employ various techniques to detect conflicts in communications related to the same order at a retail establishment, which may be crucial for maintaining smooth operations. In some implementations, the local hub synchronization system 114 may utilize timestamp comparison to prioritize communications. For example, if an order modification is received at 10:01 AM and a cancellation request at 10:02 AM (e.g., within a threshold amount of time of one another), the local hub synchronization system 114 may detect a potential conflict and determine the appropriate action based on the sequence of events.

Content analysis may also be employed by the local hub synchronization system 114 to identify discrepancies between communications. In some cases, if one communication indicates that an order should be expedited while another suggests a delay, the local hub synchronization system 114 may flag this as a conflict and alert staff for manual resolution. User identity verification may be another technique used to detect conflicts. For instance, if two different users (e.g., a customer and a staff member) send conflicting instructions for the same order, the local hub synchronization system 114 may recognize the inconsistency and prompt further investigation.

The local hub synchronization system 114 may also perform order status checks before processing new communications. In some implementations, if an order is marked as “shipped” but a new communication requests a change in the shipping address, the system may detect this conflict and prevent the change from being applied without further review. Additionally, the local hub synchronization system 114 may implement rule-based conflict detection. For example, a rule might state that an order cannot be modified after it has been marked as “completed.” If a modification request is received for a completed order, the local hub synchronization system 114 may flag this as a conflict and notify the relevant personnel. In some respects, the local hub synchronization system 114 may utilize machine learning techniques as implementing artificial intelligence (AI) to enhance conflict detection capabilities. These techniques may help ensure that conflicts are identified and resolved promptly, maintaining the integrity of the order process and potentially enhancing customer satisfaction.

Additionally, the local hub synchronization system 114 may selectively distribute an outcome of a conflict resolution to edge devices to further reduce data transmission and storage on the local network. For instance, the local hub synchronization system 114 may resolve a conflict between two entries from two separate edge devices based on type of conflict, e.g., for a single order by different edge POS devices relating to a quantity of a food item added to the order as opposed to financial transactions. The local hub synchronization system 114 may then distribute an outcome of resolving the conflict which is this instance is a quantity update to the two different edge POS devices and a KDS device to inform the kitchen of the food item quantity, while foregoing distributing the conflict resolution to a third POS device that is uninvolved with the particular order.

In this way, the local hub synchronization system 114 is configurable to manage communications 110 locally at the establishment between the edge devices 108(1)-108(4). The local hub synchronization system 114 is also configurable to support communication via the network 106 with the DSP system 102. The local hub synchronization system 114, for instance, may communicate with the DSP system 102 to resolve transactions, log the communication 110, initiate digital orders, obtain digital content (e.g., streaming digital audio), payment processing, cryptocurrency transactions, and so forth. In at least some cases, the local hub synchronization system 114 is implemented on less than each of the edge devices associated with an establishment 104 (e.g., one local hub synchronization system per establishment), which enables the edge device hosting the local hub synchronization system 114 to efficiently coordinate orders, manage conflicts, and distribute information centrally without relying on off-premise systems and long-range networks. It should be understood that by implementing the local hub synchronization system 114 at, for example, a single edge device of an establishment 104, the other edge devices of the establishment may forego such communications with the DSP system 102, further reducing network transmissions.

To do so, the DSP system 102 includes a digital service manager module 116 that is configured to implement one or more digital services 118 using hardware and software resources 120, e.g., a processing device and computer-readable storage medium that is non-transitory. Examples of digital services 118 include social media services, content streaming services, content creation services, peer-to-peer payment services, point-of-sale (PoS) services, and so forth. A variety of other examples are also contemplated.

Computing devices that implement the DSP system 102 and edge devices 108(1)-108(4) are configurable in a variety of ways. Examples of computing device configurations include a server, a desktop computer, a laptop computer, a mobile device (e.g., assuming a handheld configuration such as a tablet or mobile phone), an IoT device, a wearable device (e.g., a smart watch), an augmented reality/virtual reality device, and so forth. For the DSP system 102, for instance, clusters of graphics processing units (GPUs) are also contemplated, e.g., to accelerate implementation of artificial intelligence or other functionality. Thus, a computing device ranges from full resource devices with substantial memory and processor resources to low-resource devices with limited memory and/or processing resources. Although in instances in the following discussion reference is made to a computing device in the singular, a computing device may also represent any number of different computing devices, such as multiple servers of a server farm utilized to perform operations “over the cloud,” e.g., as part of a media content platform.

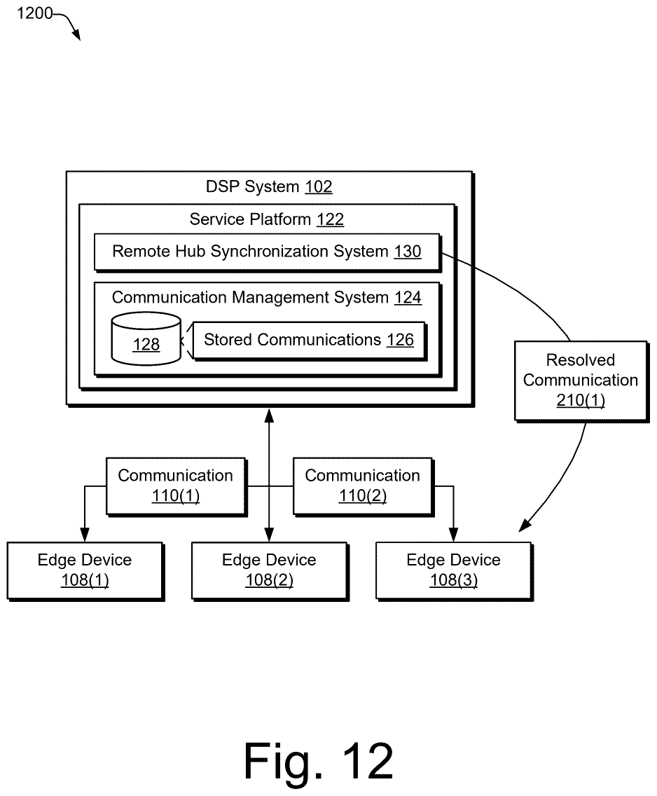

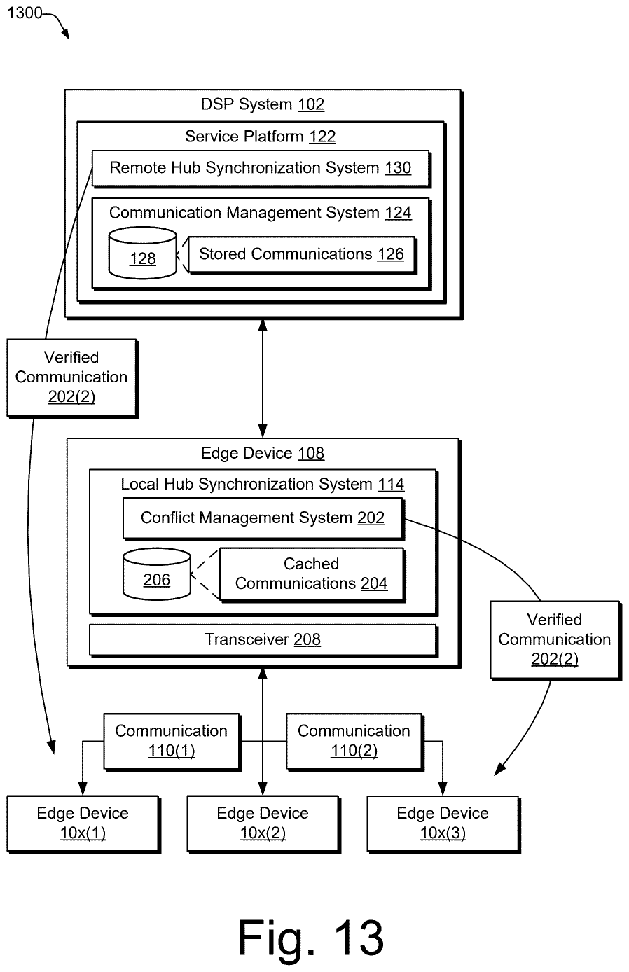

In the illustrated example, a service platform 122 is implemented by the one or more digital services 118 of the DSP system 102 to maintain and leverage functionalities based on the communications 110 of the edge devices 108(1)-108(4). These functionalities may include data logging, inventory management, transaction reconciliation, and so forth. A communication management system 124, for instance, is configured to maintain stored communications 126 in a storage device 128 and use the stored communications 126 to resolve financial transactions, order corresponding items, and so forth. The communication management system 124 may also operate to implement a remote hub synchronization system 130 as further described in relation to FIGS. 12-13 to expand functionality made available via the local hub synchronization system 114. Examples of this expanded functionality include fallback functionality, introduction to the synchronization functionality remotely before transitioning to local implementation, and so forth. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

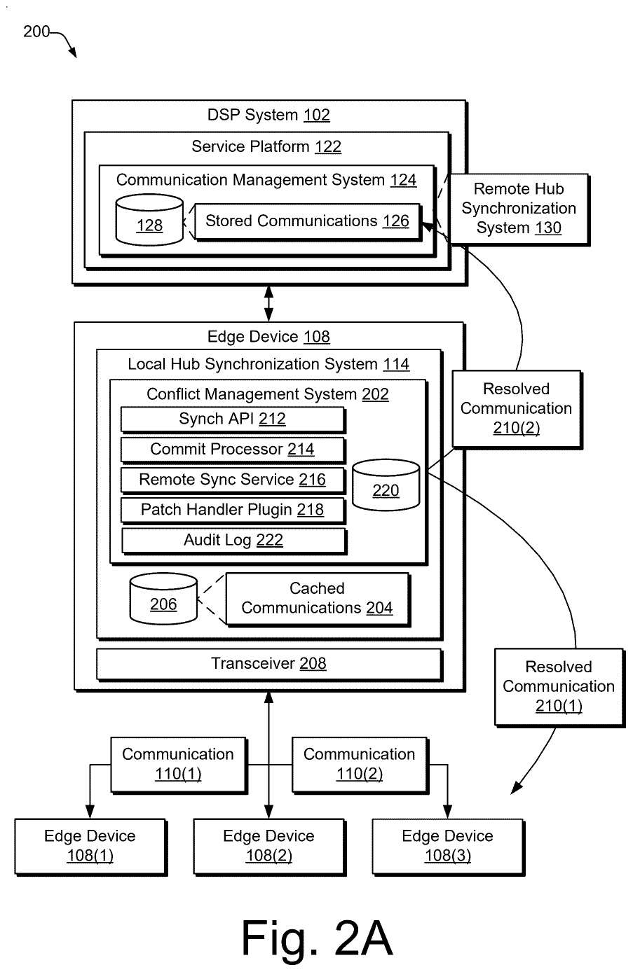

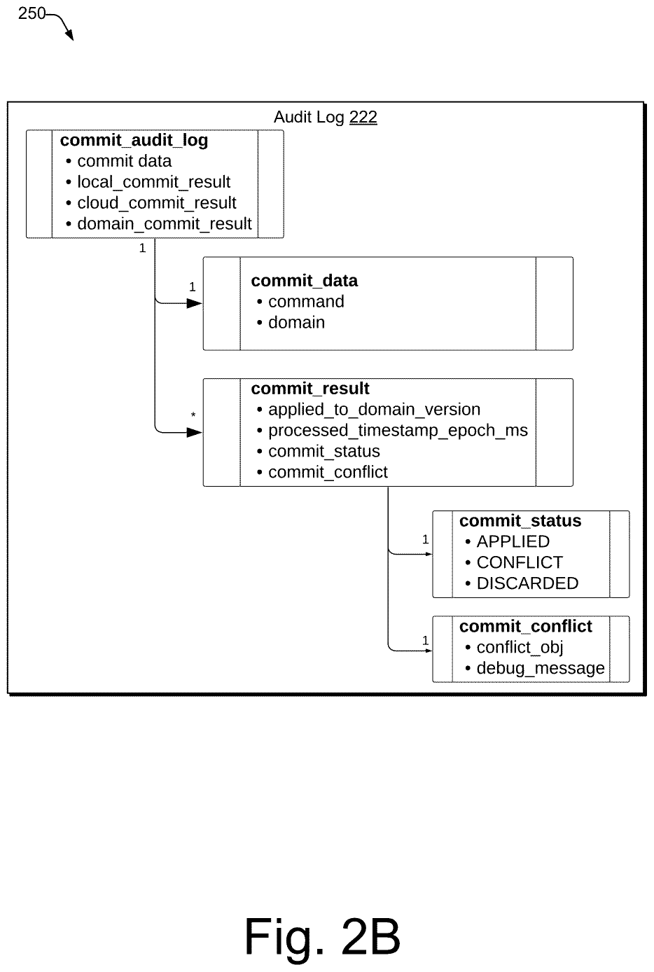

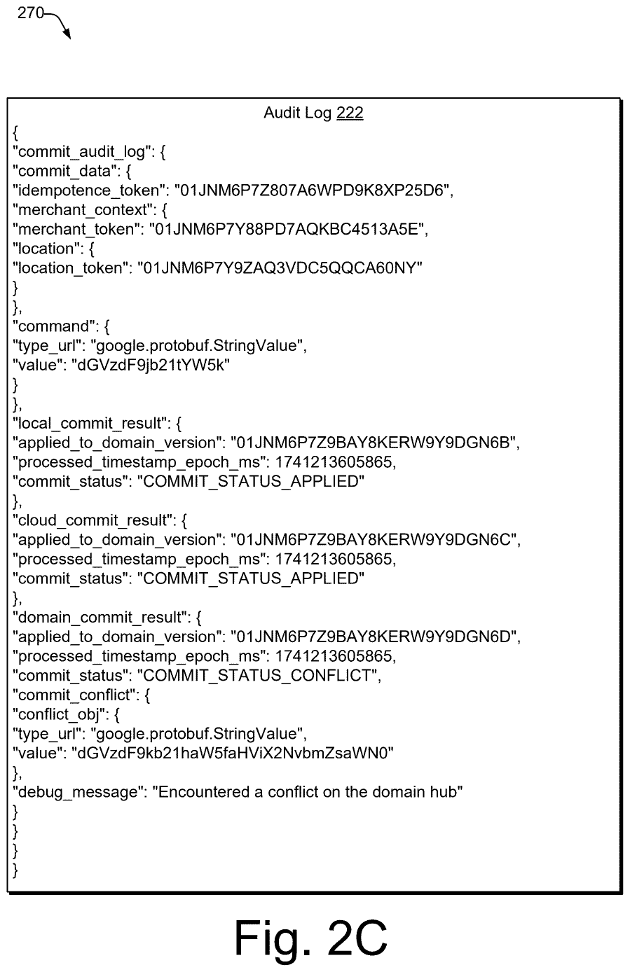

FIG. 2A depicts a system 200 in an example implementation showing operation of the local hub synchronization system 114 of FIG. 1 in greater detail as facilitating communication management in accordance with one or more implementations. The local hub synchronization system 114 in this example is implemented as software executed by an edge device 108, which may be representative of a standalone local hub synchronization device or one or more of the edge devices 108(1)-108(3).

The local hub synchronization system 114 includes a conflict management system 202. The conflict management system 202 is configurable to support robust handling of conflicting data received in communications 110(1)-110(2) from edge devices 108(1)-108(3). The conflict management system 202, for instance, is configurable to analyze incoming communications 110(1)-110(2) to detect potential conflicts, such as contradictory updates to the same data fields, i.e., parameters.

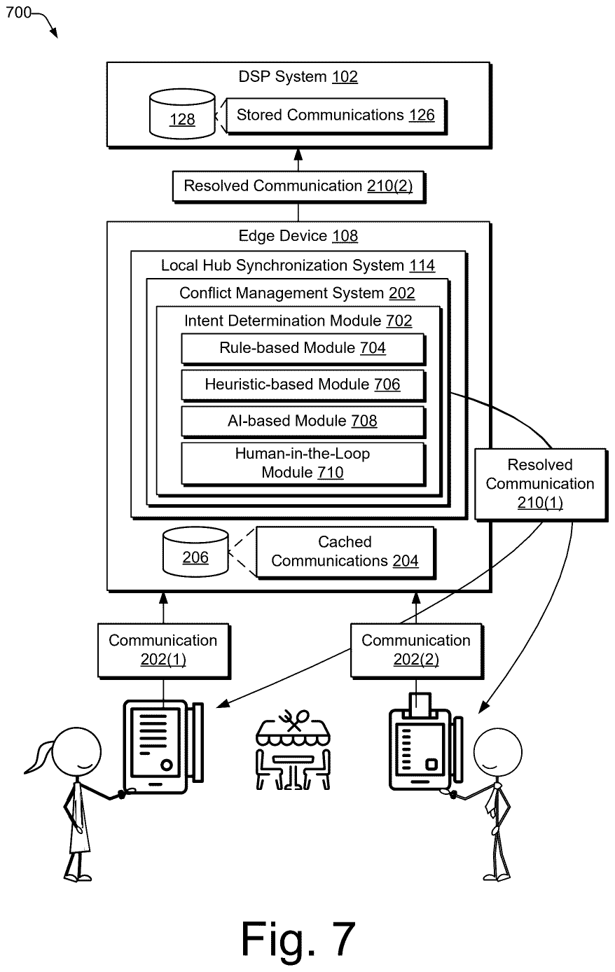

The conflict management system 202 may then employ various resolution strategies to reconcile the conflicting data. These resolution strategies may include timestamp-based prioritization, rule-based decision making, or machine learning algorithms to infer the most likely correct state, and so on as further described in relation to FIG. 7. In some instances, the conflict management system 202 may also request additional input from the edge devices or human operators to resolve complex conflicts. By managing data conflicts locally, the conflict management system 202 may reduce network traffic and enable continued operation even during periods of limited connectivity to cloud services. The resolved communications 210(1)-210(2) may then be synchronized across connected edge devices 108(1)-108(3) and the communication management system 124 of the DSP system 102 to maintain consistency.

The local hub synchronization system 114 is also configurable to utilize cached communications 204 stored in a cache 206 to enhance system performance and reliability of the communications 110(1)-110(2) as communicated between the edge devices 108(1)-108(3). The local hub synchronization system 114, for instance, may maintain a cache 206, locally, of recent communications having data updates received from the edge devices as cached communications 204. This cache 206 allows the local hub synchronization system 114 to quickly access and process frequently used information without repeated network requests. The cached communications 204 may be periodically synchronized with cloud-based services of the communication management system 124 to ensure data consistency. The local hub synchronization system 114 also employs a transceiver 208 to transmit and receive the communications, e.g., over a Wi-Fi connection, an Internet connection, and so forth.

Further, in instances of temporary network disruptions, the local hub synchronization system 114 may continue to operate using the cached communications 204, enabling the edge devices 108(1)-108(3) to maintain functionality even when network 106 connectivity is limited. The local hub synchronization system 114 may employ various caching strategies, such as time-based expiration or least-recently-used algorithms, to manage the cached communications 204 efficiently within the available storage capacity.

In this way, the local hub synchronization system 202 is configurable to implement a sophisticated caching mechanism that supports edge device access to up-to-date information even in scenarios involving temporary network outages. This enhanced reliability, combined with improved system responsiveness supports use in high-volume retail and restaurant environments involving rapid and accurate information exchange. The local hub synchronization system's architecture also provides a scalable foundation for integrating additional edge devices and digital services, offering flexibility for future expansions and adaptations.

The local hub synchronization system 114 serves as the central point of communication between on-premises edge devices 108(1)-108(4) and the DSP system 102 cloud. The local hub synchronization system 114 manages various domains, which are DSP primitives such as orders, catalog, and customers. Within each domain, entities (e.g., an order in the orders domain) and relationships are managed. These relationships may be bi-directional with assigned cardinality, existing within associated domains.

The local hub synchronization system 114 operates on a working set of entities and relationships actively created or modified during an establishment's daily activities, potentially spanning multiple domains. “Commands” identify an intent of “commits” submitted to the local hub synchronization system 114, with each commit containing a command to be executed against in-scope domains and a set of patches to be applied. A “patch” represents a single change within a commit, modifying a domain entity or its relationships.

The local hub synchronization system 114 is also configurable to employ an audit log 224, which contains a commit and statuses (local, cloud, and/or authoritative domain service or other DSP) indicating a result of applying the commit at each location, ensuring data consistency and traceability across the local hub synchronization system 114 and the DSP system 102. FIG. 2B depicts an example implementation of a hierarchical structure 250 example of an audit log of FIG. 2A in greater detail in accordance with one or more implementations. FIG. 2C depicts an example implementation of a JavaScript Object Notation (JSOM) example of an audit log 222 of FIG. 2A in greater detail in accordance with one or more implementations.

In FIG. 2B, the hierarchical structure 250 is centered around a “commit_audit_log” element 252, which contains “commit data,” a “local_commit_result,” a “cloud_commit_result,” and a “domain_commit_result.” The “commit_audit_log” element 252 connects to a “commit_data” element 254 containing “command” and “domain” information. The “commit_result” element 256 is configured to capture metadata such as “applied_to_domain_version,” “processed_timestamp_epoch_ms,” “commit_status,” and “commit_conflict.”

The “commit_result” element 256 further branches into a “commit_status” element 258 supporting values of “APPLIED,” “CONFLICT,” or “DISCARDED,” and a “commit_conflict” element 260 containing conflict_obj and debug_message fields. This structure enables comprehensive tracking of commit operations, facilitates conflict resolution, and provides debugging information.

In FIG. 2C, the audit log 222 is depicted as a structure JSON representation 270 containing a structured “commit_audit_log” object that encapsulates information about a commit operation, including commit data, command details, and commit results across local, cloud, and domain contexts. The commit data includes an “idempotence,” “merchant,” and “location” tokens providing merchant context information, while a command object specifies a type and value of the operation being performed. The audit log 222 tracks both local and cloud commit results, indicating successful application with “COMMIT_STATUS_APPLIED” status, respective domain versions, and matching timestamps.

The “domain_commit_result” section of the audit log 222 details a conflict scenario, with status “COMMIT_STATUS_CONFLICT.” This section includes detailed conflict information, such as a conflict object and a debug message stating “Encountered a conflict on the domain hub.” By maintaining this structured JSON representation 270, the local hub synchronization system 114 may enhance its ability to track changes, manage conflicts, and maintain data consistency across multiple edge devices and cloud services. The audit log 222, for instance, is configurable to ensure reliability and traceability of communications using the local hub synchronization system while providing debugging information and supporting comprehensive analysis of commit operations and corresponding outcomes.

The audit log 222, for instance, may be maintained by the local hub synchronization system 114 to support a variety of functionalities in a variety of real-world scenarios. For example, in a busy restaurant setting, the audit log 222 may be used to record each order modification, including items added, removed, or changed, along with timestamps and the specific edge devices that initiated each change. This detailed record allows the local hub synchronization system 114 to trace a history of an order if there are any discrepancies or customer inquiries.

Additionally, the audit log 222 supports troubleshooting and system optimization. For instance, in a retail environment, the local hub synchronization system 114 can use the audit log 222 to analyze patterns of inventory updates across multiple point-of-sale terminals. By examining the frequency and types of conflicts that arise between different edge devices, the local hub synchronization system 114 can identify bottlenecks or inefficiencies in inventory management processes. This data can inform decisions about staffing, device placement, or even the need for additional training to reduce conflicts and improve overall system performance which may be output as recommendations or suggestions by the local hub synchronization system 114, e.g., using generative artificial intelligence. The audit log 222 thus serves not only as a record of past events, but also as a tool for continuous improvement of operation of the local hub synchronization system 114.

In the illustrated example, the local hub synchronization system 114 includes three components including a conflict management system 202, a cache 206 of cached communications, and “cloud” synchronization through the communication management system 124. The conflict management system 202, through execution as part of the local hub synchronization system 114 resides at an establishment's 104 location, allowing edge devices 108(1)-108(4) to submit communications 110(1)-110(2) (e.g., “commits”) to a domain, e.g., inventory, financial, etc. The cache 206, also located on-premises, enables edge devices 108(1)-108(4) to read locally cached domain objects and is updated by the conflict management system 202 when processing local “commits.” The communication management system 124 operates within the DSP system 102 “cloud.”

The conflict management system 202 and cache 206 components are designable to execute on point-of-sale (POS) devices, e.g., within an inter-process communication (IPC) service registered with a local communication protocol or independent of an IPC service. This configuration allows other on-premises devices to access these components via routes registered with a local communication server, facilitating seamless local connectivity. Changes processed by the conflict management system 202 are applied to entities cached within the cache 206 component and asynchronously synchronized with the DSP system 102. In the “cloud,” a version of the local hub synchronization system 114 service (e.g., the remote hub synchronization system 130) accepts incoming commit audit log entries and processes the entries to update the state within the systems of record. The synchronization process implemented by the communication management system 124 also synchronizes cloud-sourced commits back to the local hub synchronization system 114, ensuring bi-directional data flow.

In one or more implementations, changes in the system are expressed as “commits,” each “commit” containing a command and one or more “patches.” The “patches” represent sparse updates and are configured to maintain consistency with the existing wireless protocols utilized by edge devices 108(1)-108(4) and the DSP system 102. This approach ensures compatibility and efficient data transmission throughout the local hub synchronization system 114 and its interactions with the DSP system 102.

The local hub synchronization system 114, in one or more examples, processes “commits” using a state machine. The state machine tracks the progression of each commit through various states, examples of which include “pending,” “applied,” “conflict,” “synched,” and “discard.” Each state transition is recordable in a database as part of the local hub synchronization system 114. By tracking state transitions, in the event of a system reboot or crash, the local hub synchronization system 114 can reliably repopulate its internal processing queues by referencing the stored state information. This ensures that no “commits” are lost or left in an inconsistent state, maintaining data integrity and system reliability even in the face of unexpected interruptions.

The state machine approach, coupled with persistent storage of state transitions by the cache 206, allows the local hub synchronization system 114 to resume operations seamlessly after disruptions. The local hub synchronization system 114 can “pick up where it left off” and process pending commits and resolving conflicts that are in progress at the time of the interruption. This robust design contributes to the overall reliability and fault-tolerance of the local hub synchronization system 114, enabling the local hub synchronization system 114 to provide consistent service to the edge devices 108(1)-108(4) at the establishment 104.

The conflict management system 202 includes a sync API 212, a commit processor 214, a remote sync service 216, a patch handler plugin 218 and a synch database 220. The synch API 212 is configured to receive and process “commits,” which are passed to the commit processor 214. First, the commit processor 214 validates that commits and patches are well-formed to ensure data integrity. Next, the commit processor 214 persists commits to the local datastore, creating a reliable record of each of the transactions. The commit processor 214 also delegates patch processing to the appropriate patch handler plugins 218, leveraging domain-specific logic for different types of updates. Throughout this process, the commit processor 214 manages commits through the commit state machine described above. In an implementation, each of the database writes are managed by the commit processor 214, enabling isolation of write operations and facilitating management of lock contention on the synch database 220.

The commit processor 214 is responsible for applying patches using a registered patch handler plugin 218 configured as a domain patch processor plugin for each respective patch domain. If a conflict arises during patch processing that cannot be automatically resolved, the commit processor 214 surfaces this conflict as part of a response, allowing the calling edge device 108(1)-108(4) to present the conflict to a human being for manual resolution. In some cases, the commit processor 214 may implement an artificial intelligence system, such as a generative artificial intelligence model, to intake the patches resulting in the conflict and output, for instance, a natural language prompt that describes the conflict and presents intelligent selectable options to the human being for how to proceed. Upon selection of a selectable option by the human being, the local hub synchronization system 114 can automatically implement the selected conflict resolution by, for instance, updating an item quantity, processing a transaction, modifying customer information, and so forth.

Within the local hub synchronization system 114, a commit represents the transactional boundary. The commit processor 214 processes each commit patch sequentially, and each of patches within a commit succeed before the commit processor 214 finalizes changes to the cache 206 and updates entities within the cache 206. This approach ensures transactional integrity and consistency across the entire system.

The patch handler plugin 218 within the local hub synchronization system 114 is a domain-specific component registered for particular domains. The patch handler plugin 218 processes patches by modifying the associated domain entities or relationships identified in each patch. Upon successful application of a commit, the patch handler plugin 218 returns the updated entity to the commit processor 214. The commit processor 214 then updates the cache 206 with this information and propagates the entity updates back to the calling edge device 108(1)-108(4) for direct communication of changes. Registration of the patch handler plugin 218 occurs through metadata interrogation, where the plugin itself provides descriptions of the domains and patch types the patch handler plugin 218 can process.

The patch handler plugin 218 is also responsible in this example for managing patch conflicts as deemed appropriate for the specific domain. Conflict resolution strategies implemented by the patch handler plugin 218 may include discarding a patch in favor of a new patch or surfacing the conflict to the end user at the edge device 108(1)-108(4) for manual resolution. The registration process for the patch handler plugin 218 utilizes metadata provided by the plugin, which outlines the domains and/or commands the patch handler plugin 218 is capable of processing. This metadata-driven approach allows for flexible and extensible integration of domain-specific logic within the local hub synchronization system 114.

The remote sync service 216 within the local hub synchronization system 114 is configurable to manage synchronization of commits between the local hub synchronization system 114 and the DSP system 102. The remote sync service 216 registers routes for each domain, enabling the remote sync service 216 to determine which domain-specific sync service is to handle synchronization for a particular domain. This route registration process ensures that data is directed to the appropriate cloud-based services for processing and storage.

The remote sync service 216 performs synchronization through remote calls, executing these operations asynchronously in batches. This batched, asynchronous approach allows for efficient use of network resources and helps manage potential connectivity issues. In scenarios where the DSP system 102 is temporarily unreachable, the remote sync service 216 queues the synchronization tasks within the local hub synchronization system 114. These queued tasks remain pending until connectivity with the DSP system 102 is restored, at which point the remote sync service 216 resumes the synchronization process. This mechanism ensures that data is not lost due to temporary network disruptions and maintains data consistency between the local hub synchronization system 114 and the DSP system 102.

The cache 206 within the local hub synchronization system 114 is configurable to maintain a local read-only view of domain entities including a working set for each domain. The working set may include, for example, open orders at a restaurant establishment 104 or the day's appointments at a salon establishment. The cache 206 is initially populated with data from the DSP system 102 during initialization of the local hub synchronization system 114. Subsequently, the cache 206 is updated through refreshes during domain entity commit processing, where refreshes may be periodically scheduled, take place in response to a triggering event such as an outage, or may occur according to a load balancing scheme. The cache 206, in one or more examples, does not directly transmit entities to the DSP system 102 but instead commits applied to the local hub synchronization system 114 are synchronized with the communication management system 124 to update entities there.

The cache 206 may utilize domain registration as part of its metadata, with domain owners also registering an associated domain loader plugin for each domain. These domain loader plugins initialize the entity cache for their respective domains, with the constraint that the initialization is bounded and scoped to the specific establishment 104 location. The cache 206 executes these loaders periodically on a scheduled basis to retrieve updates from the DSP system 102. To optimize this process, the cache 206 tracks a most recent domain version, allowing it to selectively retrieve entities that have been updated since the last known version. Domain initializers used by the cache 206 may implement pagination to prevent performance issues from unbounded queries.

The remote hub synchronization system 130 is configurable as a remote deployment of executable code similar to that being executed within the local hub synchronization system 114. The remote hub synchronization system 130 tags commits originating from outside digital services. When processing commits received from either the local hub synchronization system 114 or other digital services, the remote hub synchronization system 130 applies the commits in a manner consistent with the local hub synchronization system 114. This approach introduces a possibility of commits yielding different results when processed in each location, potentially leading to patch conflicts. In cases where patches result in conflicts within the environment of the DSP system 102, the remote hub synchronization system 130 tags these conflicts and synchronizes the conflicts back to the local hub synchronization system 114 for local resolution if the provided domain commit resolvers do not reach a resolution.

The remote hub synchronization system 130 is also configurable to implement an audit log processing engine to handle audit logs submitted from the local hub synchronization system 114 and other services managing domain entity types. This audit log processing engine, in one or more examples, persists audit log entries and validates the associated commits against the current domain state. For data storage, the remote hub synchronization system 130 utilizes a database in the storage device 128 to store commit audit log entries along with location-specific vector clock values. The remote hub synchronization system 130 leverages this database to identify changes that are to be synchronized back to a local hub synchronization system 114 during sync operations by comparing vector clocks. The patch handler plugins within the remote hub synchronization system 130 execute the same logic as in the local hub synchronization system 114. However, these plugins direct entity updates to the appropriate service of record for storage. The actual storage binding is abstracted behind a datastore layer interface, maintaining consistency with the interface used in the local hub synchronization system 114.

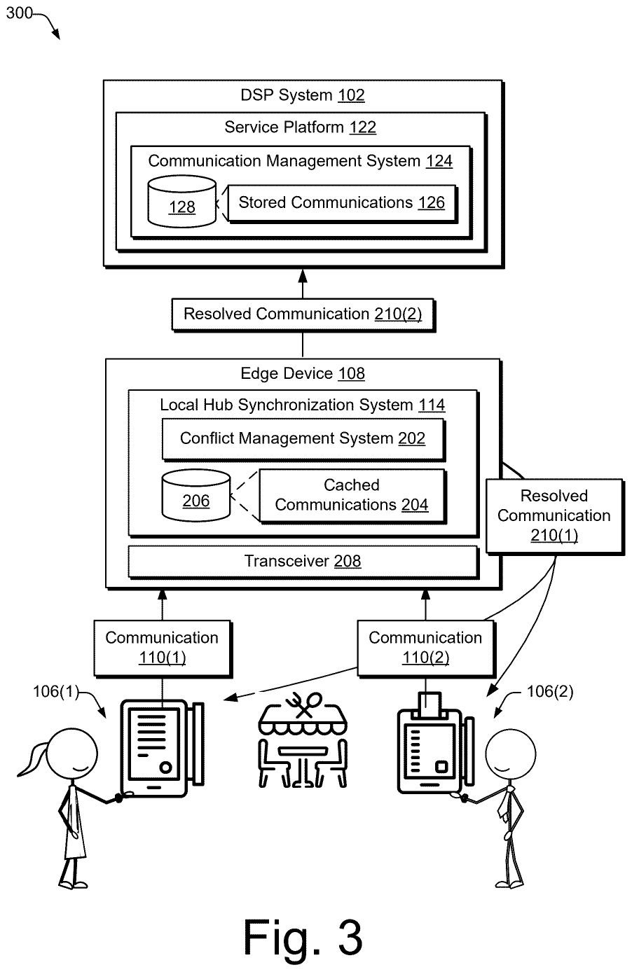

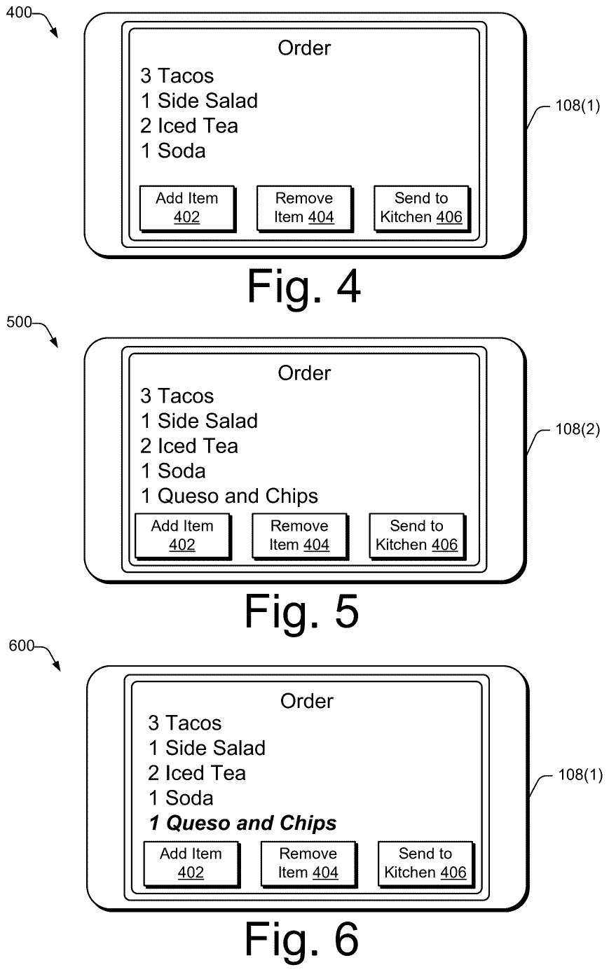

FIG. 3 depicts a system 300 in an example implementation showing operation of the local hub synchronization system 114 of FIG. 1 in greater detail as updating communications in accordance with one or more implementations. FIG. 4 depicts a system in an example implementation showing output of a user interface 400 by a first edge device 108(1) as entering items for an order. FIG. 5 depicts a system in an example implementation showing output of a user interface 500 by a second edge device 108(2) as making a change to the items in an order. FIG. 6 depicts a system in an example implementation showing output of a user interface 600 by the first edge device 108(1) as surfacing the update to the order.

In the illustrated example of FIG. 3 and the user interfaces shown in FIGS. 4-6, the local hub synchronization system 114 may process communications from multiple edge devices to manage and update an order in a restaurant setting.

Initially, the local hub synchronization system 114 receives a first communication 110(1) from the first edge device 108(1). This communication contains details of an order as displayed in the user interface 400 of FIG. 4. The order includes “3 tacos,” “1 side salad,” “2 Iced Teas,” and “1 Soda.” The user interface 400 also provides options to add items 402, remove items 404, and send the order to the kitchen 406.

Subsequently, the local hub synchronization system 114 receives a second communication 110(2) from the second edge device 108(2). This communication updates the existing order by adding “1 Queso and chips” as shown in the user interface 500 of FIG. 5. The local hub synchronization system 114 processes this update through its conflict management system 202.

In this case, no conflict is detected between the first and second communications 110(1), 110(2), as the second communication 110(2) merely adds a new item to the existing order without modifying or removing any previously added items. The conflict management system 202 determines that the update can be applied without implementation of a conflict resolution module, based on a determined intent of the two communications to add new items to the order with a threshold amount of time passing between the communications (e.g., fifteen minutes). The local hub synchronization system 114 then updates its cached communications 204 in the cache 206 to reflect the new state of the order and generates a resolved communication that combines the information from both the first and second communications.

Finally, the local hub synchronization system 114 transmits the updated order information back to the connected edge devices as resolved communication 210(1). This results in the user interface 600 of FIG. 6 being updated on the first edge device 108(1) to include the newly added “1 Queso and chips” item, which may be displayed in italics or another visually distinguishing format to indicate the recent change. This example demonstrates how the local hub synchronization system 114 may efficiently manage and synchronize order updates across multiple edge devices in real-time, ensuring connected devices have up-to-date information. A variety of other examples are also contemplated.

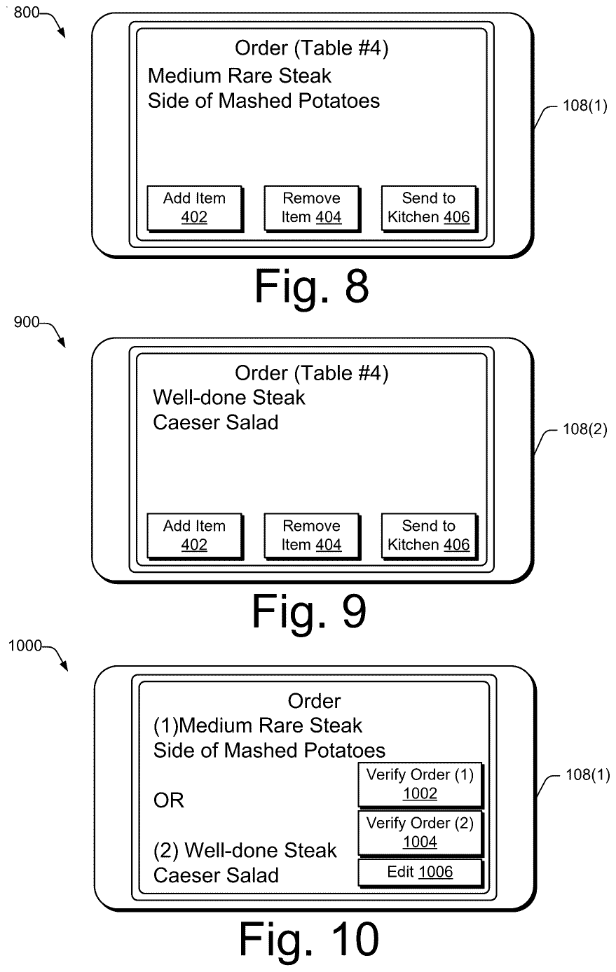

FIG. 7 depicts a system 700 in an example implementation showing operation of the local hub synchronization system 114 of FIG. 1 in greater detail as engaging in conflict resolution in accordance with one or more implementations. FIG. 8 depicts a system in an example implementation showing output of a user interface 800 by a first edge device 108(1) as entering items for an order. FIG. 9 depicts a system in an example implementation showing output of a user interface 900 by a second edge device 108(2) as entering items for an order that conflict with the items in the order from the first edge device 108(1). FIG. 10 depicts a system in an example implementation showing output of a user interface 1000 by the first edge device 108(1) as surfacing an option to resolve the conflict by a human.

In this example beginning at FIG. 7 and depicted using the user interfaces shown in FIGS. 8-10, the local hub synchronization system 114 processes conflicting communications from multiple edge devices to manage and update an order in a restaurant setting.

Initially, the system receives a first communication 202(1) from the first edge device 108(1). This first communication 202(1) contains details of an order as displayed in the user interface 800 of FIG. 8. The order includes a “Medium Rare Steak” and a “side of mashed potatoes.” The user interface 800 also provides options to add items 402, remove items 404, and send the order to the kitchen 406.

Subsequently, or substantially simultaneously, the system receives a second communication 202(2) from the second edge device 108(2). This communication appears to update the existing order, but with conflicting information. As shown in the user interface 900 of FIG. 9, the order now includes a “well-done steak” and a “Caesar salad,” which differs significantly from the original order.

The local hub synchronization system 114 processes these communications through its conflict management system 202. The intent determination module 702 analyzes the communications and detects a conflict between the steak preparations (medium rare vs. well-done) and the side dishes (mashed potatoes vs. Caesar salad). In some scenarios, the conflict management system 202 may determine that a conflict exists based on time elapsed between the first and second communications being less than a threshold.

A context describes environmental factors in which a communication occurs, e.g., time, location, device state, network conditions, user role, and historical interactions between users or between user and edge devices. The context is then usable to infer intent by the local hub synchronization system 114 by extracting an intended purpose behind an action by analyzing a context defined using patterns, decision-making frameworks, and user behaviors to determine the desired outcome. The inferred intent is then used as a basis to resolve the conflict. Thus, conflict resolution involving detecting a context including which conditions exist when data conflicts occur and then resolving contention by prioritizing or arbitrating based on an intent inferred from the context. Thus, intent inference detects what particular action was intended and subsequent conflict resolution determines which conflict resolution module best aligns with a technical outcome that is aligned with that intent.

In some implementations, the local hub synchronization system 114 executes a variety of techniques to infer intent behind a respective communication as illustrated using the respective executable modules as further described below. In some implementations, the local hub synchronization system 114 selectively applies one or a combination of the techniques depending on a context around edge devices, e.g., time of the day, nature of the seller items, etc. Examples of these techniques include timestamp-based resolution, where a more recent transaction takes precedence; priority-based resolution, where certain devices, instructions, or transaction types are given higher priority; merge-based resolution, which combines non-conflicting parts of transactions; heuristic or rule-based resolution, and so forth.

The local hub synchronization system 114, in the illustrated example, attempts to resolve the conflict using its various executable modules in an effort to infer an intent behind the communications, examples of which include a rule-based module 704, a heuristic-based module 706, and AI-based module 708 may attempt to determine the correct order based on predefined rules, past patterns, or machine learning algorithms as automated using these techniques. The rule-based module 704 may resolve conflicts between orders by applying predefined rules and logic to determine the most appropriate resolution. In the case of conflicting orders for “medium rare steak” with “side of mashed potatoes” versus “well-done steak” with “Caesar salad,” for instance, the rule-based module 704 may first identify specific conflicting elements: steak doneness and side dish. The rule-based module 704 may then apply rules such as prioritizing the most recent order, considering the typical preferences of the specific customer if available, or defaulting to the more conservative option for food safety, e.g., well-done steak.

For the side dish conflict, the rule-based module 704 may check if there are any dietary restrictions or allergies associated with the customer's profile that would influence the choice between mashed potatoes and Caesar salad. If no clear resolution can be determined based on the predefined rules, the rule-based module 704 may flag the conflict for human intervention, e.g., by presenting both options to the server, manager, or kitchen staff for confirmation. In some implementations, the rule-based module 704 may also consider factors such as inventory levels or preparation times to optimize kitchen operations when resolving such conflicts.

The heuristic-based module 706 may employ experience-based techniques to resolve conflicts between orders such as “medium rare steak” with “side of mashed potatoes” versus “well-done steak” with “Caesar salad.” To do so, the heuristic-based module 706 may analyze historical data and patterns to make informed decisions. For instance, the heuristic-based module 706 may consider factors such as the frequency of similar conflicts, the typical resolution outcomes, and the time of day or day of the week when the orders were placed. The heuristic-based module 706 may also take into account customer preferences if available, such as previous orders from the same table or customer profile.

In some implementations, the heuristic-based module 706 may weigh the likelihood of each order being correct based on popular menu combinations or seasonal trends. The heuristic-based module 706 may also consider the current kitchen workload and preparation times, potentially favoring the option that aligns better with ongoing food preparation. If the heuristic analysis yields a high confidence resolution, the module may automatically apply it. However, if the confidence level falls below a certain threshold, the heuristic-based module 706 may flag the conflict for human review, possibly suggesting the most likely correct order based on its analysis.

The AI-based module 708 may leverage a machine-learning model and artificial intelligence techniques to resolve conflicts between orders such as “medium rare steak” with “side of mashed potatoes” versus “well-done steak” with “Caesar salad.” The AI-based module 708, for instance, may analyze various factors including historical order data, customer preferences, time of order, and current restaurant conditions. In some implementations, the AI-based module 708 may consider contextual information such as the customer's previous orders, dietary restrictions, or even social media preferences if available. The AI-based module 708 may also take into account real-time data like kitchen inventory, staff availability, and current order volume.

The local hub synchronization system 114, for example, may encounter scenarios where conflicting communications are received from different edge devices 108(1)-108(4). For instance, a first communication 110(1) from a first edge device 108(1) operated by a server might add an item to an order, while a second communication 110(2) from a second edge device 108(2) in the kitchen removes the same item. In such cases, the conflict management system 202 within the local hub synchronization system 114 employs conflict resolution modules to resolve the discrepancy based on an intent inferred from a context of the communications.

The intent determination module 702, for instance, analyzes the conflicting communications using multiple approaches. The heuristic-based module 706 may examine whether the kitchen's action of removing the item indicates that the order has already been fulfilled, suggesting that the server's update might be outdated. Concurrently, the AI-based module 708 leverages machine learning models as part of artificial intelligence to predict a most likely correct resolution based on historical transaction patterns and user behavior. For example, if past data shows that late additions by servers are often cancelled by the kitchen due to timing constraints, the system might prioritize the kitchen's removal action. Additionally, the rule-based module 704 may apply predefined logic, such as giving precedence to a most recent action or considering the roles of the users involved in the conflicting communications. By combining these analytical methods, the local hub synchronization system 114 can make informed decisions to resolve conflicts and maintain data consistency across each of the connected edge devices at a given establishment.

By processing these diverse inputs, the AI-based module 708 may predict a correct order or suggest a compromise solution based on a probability determination. For instance, the AI-based module 708 may determine that based on the customer's history and the current time of day, the “medium rare steak” has a higher degree of probability of being correct, but the “Caesar salad” is a better fit given recent ordering trends. The AI-based module 708 may also assess the confidence level of its decision and, if below a certain threshold, flag the conflict for human review while providing its analysis to assist in the resolution process.

In the illustrated example of FIG. 10, the conflict management system 202 determines that the confidence level is too low to resolve automatically. As a result, a human-in-the-loop module 710 is activated. The system generates a combined order interface 1000 as shown in FIG. 10, which displays both versions of the order. The interface presents the conflicting orders side by side, with order (1) showing the medium rare steak and mashed potatoes, and order (2) showing the well-done steak and Caesar salad. The combined order interface 1000 includes options for human intervention. The user interface 1000 includes verify options 1002, 1004 as selectable controls for each order, respectively, to prompt a staff member to confirm which order is correct. An edit option 1006 is also provided, allowing for manual adjustment of the order if needed.

In some scenarios, the conflict management system 202 may leverage a generative artificial intelligence (AI) model to dynamically generate recommendations related to the options presented to a human for resolution of a conflict. In addition to the illustrated example of FIG. 10, the conflict management system 202, for instance, may present a recommendation to a human to proceed with order (1) based on inventory quantities of mashed potatoes, for instance. In this way, the conflict management system 202 may increase efficiencies of a merchant for inventory, order processing, staffing, and payments as part of the conflict resolution process. In another instance, the conflict management system 202 provides the recommendation based on resource availability, e.g., inventory, staffing, financial, and so forth. The conflict management system 202, for instance, may output a recommendation for a particular menu item based on availability of ingredients, aging of the ingredients, and so forth.

This example demonstrates how the local hub synchronization system 114 can detect and manage complex conflicts in real-time. By surfacing the conflict for human resolution, the local hub synchronization system 114 ensures that the final order is accurate, maintaining the quality of service in the restaurant setting. Once the conflict is resolved by human intervention, the local hub synchronization system 114 updates each of the connected edge devices with correct order information, ensuring consistency across the entire system.

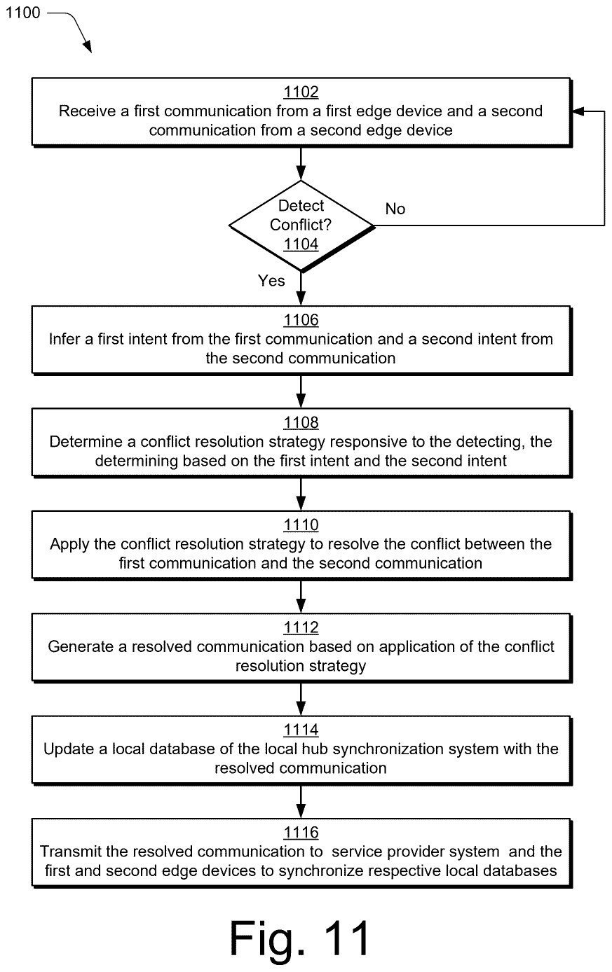

FIG. 11 is a flow diagram depicting an algorithm as a step-by-step procedure 1100 in an example implementation of operations performable for accomplishing a result of local hub synchronization and conflict resolution in one or more implementations. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

A first communication is received from a first edge device and a second communication is received from a second edge device (block 1102). For example, the local hub synchronization system 114 may receive a first communication 110(1) from a first edge device 108(1) detailing items in an order including “3 tacos,” “1 side salad,” “2 Iced Teas,” and “1 Soda,” and a second communication 110(2) from a second edge device 108(2) updating the order to add “1 Queso and chips.”

The local hub synchronization system 114 then detects whether there is a conflict between the first and second communications (block 1104). The conflict management system 202, for instance, analyzes the incoming communications to identify any contradictory or inconsistent information. If no conflict is detected, the procedure 1100 returns to the receiving step (block 1102) to process additional communications.

If a conflict is detected, the local hub synchronization system 114 infers a first intent from the first communication and a second intent from the second communication (block 1106). The intent determination module 702 may analyze the content and context of each communication to discern the underlying purpose or goal of the update. The local hub synchronization system 114 may employ various techniques to infer intent from communications received from edge devices. In some implementations, the local hub synchronization system 114 may utilize Natural Language Processing (NLP) to analyze text-based communications.

A context describes environmental factors in which a communication occurs, e.g., time, location, device state, network conditions, user role, and historical interactions between users or between user and edge devices. The context is then usable to infer intent by extracting an intended purpose behind an action by analyzing patterns, decision-making frameworks, and user behaviors to determine the desired outcome based on the context. The inferred intent is then used as a basis to resolve the conflict. Thus, conflict resolution detects a context including conditions exist when data conflicts occur and then resolves contention by prioritizing or arbitrating based on an intent inferred from the context. Intent inference detects a particular action was intended and subsequent conflict resolution determines which conflict resolution module best aligns with a technical outcome that is aligned with that intent.

In some implementations, the local hub synchronization system executes a variety of techniques to infer intent behind a respective communication. In some implementations, the local hub synchronization system selectively applies one or a combination of the techniques depending on a context around edge devices, e.g., time of the day, nature of the seller items, etc. Examples of these techniques include timestamp-based resolution, where a more recent transaction takes precedence; priority-based resolution, where certain devices, instructions, or transaction types are given higher priority; merge-based resolution, which combines non-conflicting parts of transactions; heuristic or rule-based resolution, and so forth.

In an example, a communication from an edge device may specify removal of items from an order while another communication from another edge device, obtained simultaneously or in near-real time to the first communication, may specify additional items. Therefore, an intent that is inferred indicating that the orders exhibit that someone “changed their mind” will cause the local hub device to resolve the conflict by removing the first communication and implementing actions corresponding to the second communication.

In another example, if a first edge device submits a price change for an item while a second edge device simultaneously submits an inventory update for the same item, the local hub synchronization system may readily determine intent behind the change and the update. The local hub synchronization system may then apply a rule that allows both changes to coexist as the intents do not conflict and thereby update both the price and inventory. In cases where direct reconciliation is not possible, the local hub synchronization system may implement a queueing mechanism to process transactions sequentially or escalate the conflict to a secondary resolution mechanism manned by a human operator for manual resolution or through a secondary intent resolution process (e.g., a different technique than previously executed).

Contextual analysis may also be employed by the system to determine intent. In some cases, such as in a smart home system, if a user says, “It's too hot in here,” the local hub synchronization system 114 may interpret this as an intent to lower the temperature and adjust the thermostat accordingly, even though a corresponding manually entered change was to raise the temperature using a thermostat. The local hub synchronization system 114 may also analyze behavioral patterns to infer intent. For instance, the local hub synchronization system 114 may track a user's browsing history and, upon noticing frequent views of running shoes, prioritize running shoe selections when faced with a conflict using other types of shoes.

In some scenarios, the local hub synchronization system 114 may utilize machine learning models to predict user intent based on past behavior. A music streaming service, for example, may analyze a user's listening habits. Additionally, the local hub synchronization system 114 may employ sentiment analysis to determine intent. If a customer service platform receives a message expressing frustration with a recent purchase, the system may prioritize the message for immediate attention by a support agent based on the detected negative sentiment. These techniques may help the local hub synchronization system 114 understand and respond to user intents more accurately, potentially enhancing the overall user experience and improving the efficiency of communication processing across connected edge devices.

Next, the local hub synchronization system 114 determines a conflict resolution strategy responsive to the detecting, with the determining based on the first intent and the second intent (block 1108). The local hub synchronization system 114 may employ various techniques, examples of which are represented as a rule-based module 704, heuristic-based module 706, or AI-based module 708 to select an appropriate strategy for resolving the conflict based on the inferred intents.

The local hub synchronization system 114 then applies the conflict resolution strategy to resolve the conflict between the first communication and the second communication (block 1110). Application of the strategy may involve implementing predefined rules, using experience-based techniques, or leveraging machine learning algorithms to determine an appropriate resolution. Following the application of the resolution strategy, the local hub synchronization system 114 generates a resolved communication based on application of the conflict resolution strategy (block 1112). This resolved communication represents the reconciled state of the data after addressing the conflict. These diverse conflict resolution strategies enable the local hub synchronization system to maintain data consistency across each of the connected edge devices while adapting to various types of conflicts that may arise.

A local database of the local hub synchronization system 114 is then updated with the resolved communication (block 1114). This step may involve storing the resolved data in the cached communications 204 within the cache 206 of the local hub synchronization system 114. The local hub synchronization system 114 also transmits the resolved communication to the service provider system and the first and second edge devices to synchronize respective local databases (block 1116). This transmission ensures that each of the connected devices and systems have the most up-to-date and consistent information following the conflict resolution.

FIG. 12 illustrates a synchronization system 1200 that demonstrates how a remote hub synchronization system 130 is usable to introduce edge devices to the functionality of a local hub synchronization system without involving actual implementation at a respective establishment. This approach, for instance, may be used to allow merchants to “try out” the system before committing to a full local installation.

In this configuration, the DSP system 102 incorporates a service platform 122 that hosts the remote hub synchronization system 130. The remote hub synchronization system 130 is configurable to emulate the functions of a local hub synchronization system 114, e.g., processing communications and managing conflicts in a manner similar to how a local system would operate.

In this example, multiple edge devices 108(1), 108(2), and 108(3) communicate directly with the establishment 104 through the network 106. These edge devices 108(1), 108(2), and 108(3) may send communications 110(1), 110(2)) to the remote hub synchronization system 130, which processes the communications as if it were a local system. In an implementation, the remote hub synchronization system 130 includes application programming interfaces in a manner that mimics operation of the local hub synchronization system 114.

The remote hub synchronization system 130 is also configurable to handle conflict resolution, data synchronization, and other functions typically performed by a local hub. The communication management system 124, as previously described, may store and manage communications in the storage device 128, allowing for data persistence and retrieval as needed. This implementation provides a realistic simulation of operation of the local hub synchronization system 114, giving merchants the opportunity to evaluate the benefits and functionality of the system without the need for immediate on-premises hardware installation or software deployment. By utilizing this remote configuration, establishments may gain familiarity with the capabilities of the local hub synchronization system 114, assess an operational impact, and make informed decisions about implementing a local hub synchronization system 114 in the future. This approach may offer a low-risk way to transition towards a more robust, locally-managed synchronization solution.

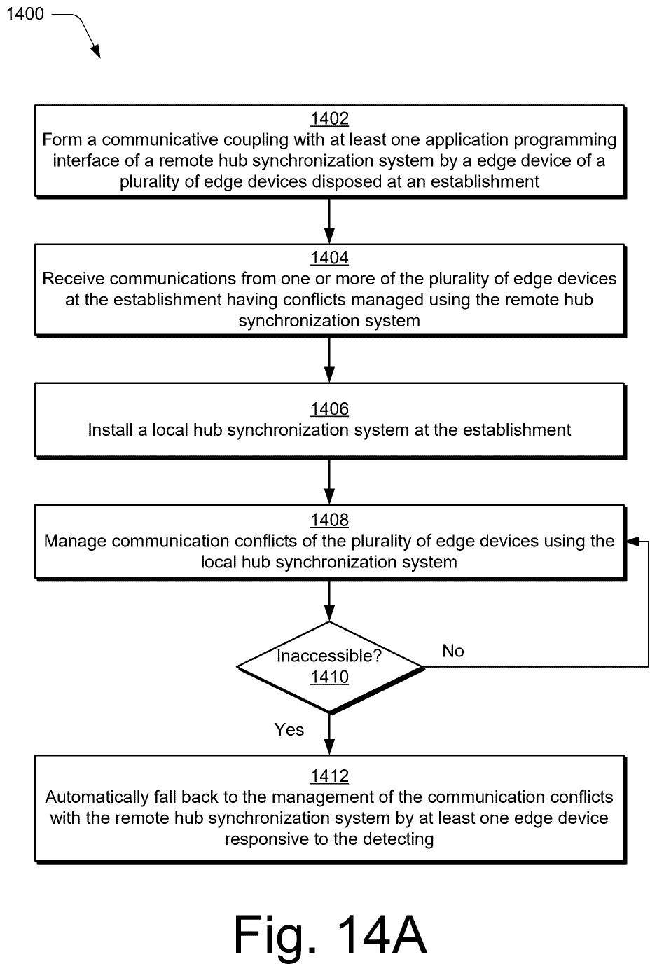

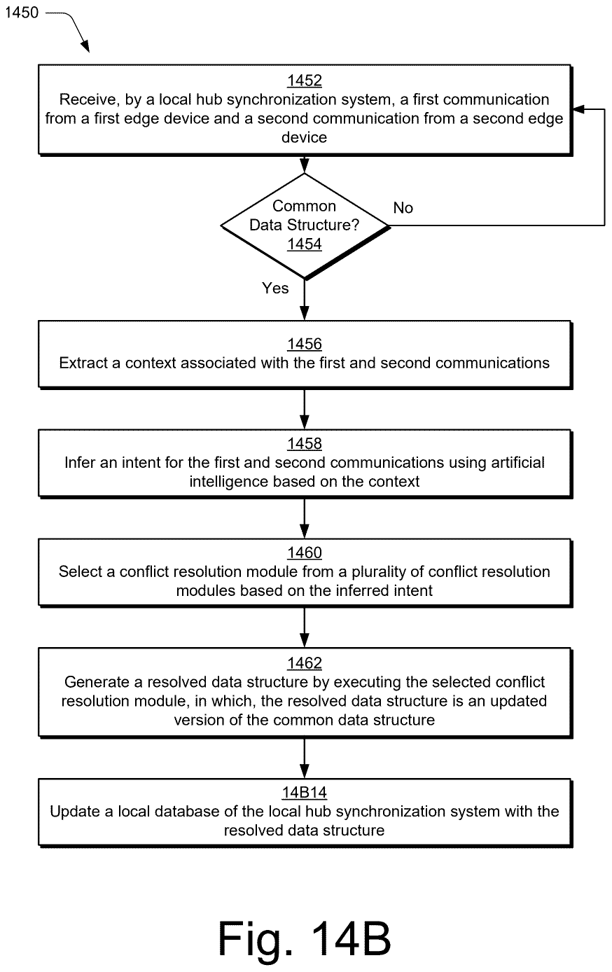

FIG. 13 illustrates a system 1300 showing initial implementation of a remote hub synchronization system, introduction of a local hub synchronization system, and use of the remote hub synchronization system as a fallback in one or more implementations. FIG. 14A is a flow diagram depicting an algorithm as a step-by-step procedure 1400 in an example implementation of operations performable for accomplishing a result of remote and local hub synchronization and conflict resolution in one or more implementations. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm (e.g., method) as illustrated by the flow diagram. As a result, the instructions are storable on a computer-readable storage medium that causes the hardware to perform the algorithm.

A communicative coupling is initiated with at least one application programming interface of a remote hub synchronization system 130 by an edge device of a plurality of edge devices disposed at an establishment (block 1402). For example, edge devices 108(1), 108(2), and 108(3) may establish connections with the remote hub synchronization system 130 within the DSP system 102.

Communications are received from one or more of the plurality of edge devices at the establishment having conflicts managed using the remote hub synchronization system 140 (block 1404). The remote hub synchronization system 130, for instance, may process communications 110(1) and 110(2) from the edge devices, resolving conflicts as detected.

Next, a local hub synchronization system 114 is installed at the establishment (block 1406). Installation may include deploying software of the local hub synchronization system 114 on the fourth edge device 108(4), which will serve as the local hub for the establishment.

Communication conflicts of the plurality of edge devices are then managed using the local hub synchronization system (block 1408). At this stage, the local hub synchronization system 114 takes over the conflict management responsibilities, processing communications through its conflict management system 202 and maintaining cached communications 204 in the cache 206.

A determination is then made as to whether the local hub synchronization system is inaccessible (decision block 1410). This may occur due to hardware failures, network issues, or other unforeseen circumstances affecting the fourth edge device 108(4).

If the local hub synchronization system is detected as inaccessible (“yes” from decision block 1410), a fallback technique is implemented to cause management of the communication conflicts by the remote hub synchronization system (block 1412). In this scenario, the edge devices 108(1), 108(2), and 108(3) may revert to communicating with the remote hub synchronization system 130 in the service provider system 1302, ensuring continuity of operations and remain operating with the local hub synchronization system 114 if accessible (“no” from decision block 1410). Throughout this process, the fourth edge device 108(4) facilitates communication between the local hub synchronization system 114 and both the edge devices and the service provider system 1302. This architecture enables a seamless transition between local and remote conflict management, providing robust synchronization capabilities for the establishment.

FIG. 14B is a flow diagram depicting an algorithm as a step-by-step procedure 1450 in an example implementation of operations performable for accomplishing a result of remote and local hub synchronization and conflict resolution in one or more implementations. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm (e.g., method) as illustrated by the flow diagram. As a result, the instructions are storable on a computer-readable storage medium that causes the hardware to perform the algorithm.

A first communication from a first edge device and a second communication from a second edge device is received (block 1452) by a local hub synchronization system 114. The local hub synchronization system 114, for instance, receives communications from multiple edge devices, such as a first communication from a first edge device 108(1) and a second communication from a second edge device 108(2). In a restaurant setting, for example, the first edge device 108(1) might be a point-of-sale terminal where a server enters an order for a medium-rare steak, while the second edge device 108(2) could be a kitchen display system where a chef updates the order to indicate the steak is being prepared well-done

A determination is then made by the local hub synchronization system as to whether the first and second communications have a common data structure (decision block 1454). If not, the procedure 1450 returns to receipt of communications (“no” from decision block 1454 to block 1452). In one or more examples, the local hub synchronization system 114 examines the received communications to determine if the communications share a common data structure, e.g., as defined by a database schema. This comparison ensures that the system can properly process and reconcile the data structures, one to another. For instance, both the point-of-sale terminal and the kitchen display system may use a standardized order format that includes fields for table number, item description, and preparation instructions. If the communications do not share a common structure, the local hub synchronization system 114 continues to monitor for new incoming communications.

If the first and second communications have a common data structure (“yes” from decision block 1454), a context associated with the first and second communications is extracted (block 1456). The context including at least one of a timestamp of the transaction update, a device type identifier, a user role, or a network connectivity status. In one or more examples, when the local hub synchronization system 114 confirms that the communications have a common data structure, the local hub synchronization system 114 extracts relevant context from the communications. This context may include details such as the timestamp of when the server entered the original order and when the chef updated it, identifiers for the specific devices used, the roles of the users (server and chef), and the current network status of each edge device.

An intent is then inferred for the first and second communications using artificial intelligence based on the context (block 1458). The inference is based on a historical transaction pattern analysis, a predefined heuristic-based conflict resolution rule, or a user behavior prediction model. In this example, the local hub synchronization system 114 employs artificial intelligence techniques as implemented by one or more machine-learning models to infer the intent behind the communications based on the extracted context. For example, the local hub synchronization system 114 may analyze historical patterns of order modifications in the restaurant, apply predefined rules about how to handle discrepancies between front-of-house and kitchen staff inputs, or use a machine-learning model to implement artificial intelligence that predicts likely user behaviors based on past interactions. In this case, the artificial intelligence might infer that the chef's update to the steak's preparation method takes precedence over the server's initial input.

A conflict resolution module is selected from a plurality of conflict resolution modules based on the inferred intent (block 1460). Based on the inferred intent, the local hub synchronization system 114 selects a conflict resolution module that is configured to handle the conflict. For the steak order example, for instance, the local hub synchronization system 114 might choose an executable module specifically designed to resolve discrepancies in food preparation instructions. This executable module may be programmed to prioritize kitchen staff inputs over initial order entries, ensuring that the final order reflects the actual preparation of the dish

A resolved data structure is generated by executing the selected conflict resolution module, in which, the resolved data structure is an updated version of the common data structure (block 1462). The data structure, for instance, may be resolved to edit data itself, metadata, a schema, and so forth. A local database of the local hub synchronization system is then updated with the resolved data structure (block 1464), e.g., cached to local storage.

The local hub synchronization system 114, for example, may encounter scenarios where conflicting communications are received from different edge devices 108(1)-108(4). For instance, a first communication 110(1) from a first edge device 108(1) operated by a server might add an item to an order, while a second communication 110(2) from a second edge device 108(2) in the kitchen removes the same item. In such cases, the conflict management system 202 within the local hub synchronization system 114 employs conflict resolution modules to resolve the discrepancy based on an intent inferred from a context of the communications.

The intent determination module 702, for instance, analyzes the conflicting communications using multiple approaches. The heuristic-based module 706 may examine whether the kitchen's action of removing the item indicates that the order has already been fulfilled, suggesting that the server's update might be outdated. Concurrently, the AI-based module 708 leverages machine learning models as part of artificial intelligence to predict a most likely correct resolution based on historical transaction patterns and user behavior. For example, if past data shows that late additions by servers are often cancelled by the kitchen due to timing constraints, the system might prioritize the kitchen's removal action. Additionally, the rule-based module 704 may apply predefined logic, such as giving precedence to a most recent action or considering the roles of the users involved in the conflicting communications. By combining these analytical methods, the local hub synchronization system 114 can make informed decisions to resolve conflicts and maintain data consistency across each of the connected edge devices at a given establishment.

FIG. 15 illustrates an example environment 1500 in which recommendation techniques described herein are performed in accordance with one or more implementations. The environment 1500 includes server(s) 1502 that can communicate over a network 1504 with end user devices 1506 and/or server(s) 1508 associated with third-party service provider(s). In various examples, the end user devices 1506 may comprise one or more seller devices 1506(A), one or more user devices 1506(B) and/or 1506(C) in a peer network, one or more content consumption devices 1506(D), one or more artist devices 1506(E), combinations of these examples, or other categories of user devices. The server(s) 1502 can be associated with one or more service providers that can provide one or more services for the benefit of users 1516, as described below. For example, the server(s) 1502 may enable services of service providers such as in association with a seller platform 1510 (which may further include a buyer platform), a peer-to-peer (P2P) payment platform 1512, a media content platform 1514, a combination of these platforms, or other platforms associated with other service providers. While services and features are referenced throughout in connection with a particular one of the seller platform 1510, the P2P payment platform 1512, or the media content platform 1514, it should be understood that any of these platforms may perform the functionality described in relation to any of the other platforms. Actions attributed to the service provider(s) can be performed by the server(s) 1502, e.g., for the DSP system 102.

In some examples, individual ones of the end user devices 1506 can be operable by users 1516. The users 1516 (individually referred to herein as “user 1516”) can be referred to as customers, buyers, merchants, sellers, borrowers, employees, employers, payors, payees, couriers, artists, musicians, listeners, fans, supervisors, hosts, audience members, and so on. The users 1516 can interact with the end user devices 1506 via user interfaces presented via the end user devices 1506. In at least one example, a user interface can be presented via a web browser, or the like. Alternatively or additionally, a user interface can be presented via an application, such as a mobile application or desktop application, which can be provided by the seller platform 1510, the P2P payment platform 1512, and/or the media content platform 1514, or which can be an otherwise dedicated application. In some examples, individual end user devices 1506 can have an instance or versioned instance of an application, which can be downloaded from an application store, for example, which can present the user interface(s) described herein.

In at least one example, the users 1516 can include merchants that can operate the seller device(s) 1506(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1506(A) can have an instance of a point of sale (“POS”) application 1520 stored thereon. The POS application 1520 can configure the seller device 1506(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1520 can determine transaction data associated with the POS transactions. Transaction data can include payment information, which can be obtained from a reader device 1522 associated with the seller device 1506(A), user authentication data, purchase amount information, point-of-purchase information (e.g., item(s) purchased, date of purchase, time of purchase, subscription type, etc.), etc. The POS application 1520 can send transaction data to the server(s) 1502 such that the server(s) 1502 can track transactions of the customers, merchants, and/or the users 1516 over time. Furthermore, the POS application 1520 can present a UI to enable the merchant to interact with the POS application 1520 and/or the seller platform 1510 via the POS application 1520.

In at least one example, the seller device 1506(A) can be a special-purpose computing device configured as a POS terminal (via the execution of the POS application 1520). In at least one example, the POS terminal may be connected to a reader device 1522, which is capable of accepting a variety of payment instruments, such as credit cards, debit cards, gift cards, short-range communication based payment instruments, and the like, as described below. In at least one example, the reader device 1522 can plug in to a port in the seller device 1506(A), such as a microphone port, a headphone port, an audio-jack, a data port, or other suitable port. In additional or alternative examples, the reader device 1522 can be coupled to the seller device 1506(A) via another wired or wireless connection, such as via Bluetooth®, BLE, and so on. In some examples, the reader device 1522 can be a software solution executing on the POS terminal, e.g., a mobile phone. In some examples, the reader device 1522 can read information from alternative payment instruments including, but not limited to, wristbands and the like.

In some examples, the reader device 1522 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 1522, and communicate with the seller platform 1510, which can provide, among other services, a payment processing service. The server(s) 1502 associated with the seller platform 1510 can communicate with server(s) 1508, as described below. In this manner, the POS terminal and reader device 1522 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1522 of the POS system 1524 are shown as separate devices, in additional or alternative examples, the POS terminal and the reader device 1522 can be part of a single device. In some examples, the reader device 1522 can have a display integrated therein for presenting information to customers of a merchant. In additional or alternative examples, the POS terminal can have a display integrated therein for presenting information to the customers of the merchant. POS systems, such as the POS system 1524, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1522, whereby the reader device 1522 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1524, the server(s) 1502, and/or the server(s) 1508 may exchange payment information and transaction data to determine whether transactions are authorized. For example, the POS system 1524 may provide encrypted payment data, user authentication data, purchase amount information, point-of-purchase information, etc. (collectively, transaction data) to server(s) 1502 over the network(s) 1504. The server(s) 1502 may send the transaction data to the server(s) 1508.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1508 associated therewith) can forward the fund transfer request to an issuing bank (e.g., “issuer”). The issuer is a bank or financial institution that offers a financial account (e.g., credit or debit card account) to a user. The issuer (e.g., the server(s) 1508 associated therewith) can make a determination as to whether the customer has the capacity to absorb the relevant charge associated with the payment transaction. In at least one example, the seller platform 1510 can serve as an issuer and/or can partner with an issuer. The transaction is either approved or rejected by the issuer and/or the card payment network (e.g., the server(s) 1508 associated therewith), and a payment authorization message is communicated from the issuer to the POS device via a path opposite of that described above, or via an alternate path.

The server(s) 1508 may send an authorization notification over the network(s) 1504 to the server(s) 1502, which may send the authorization notification to the POS system 1524 over the network(s) 1504 to indicate whether the transaction is authorized. The server(s) 1502 may also transmit additional information such as transaction identifiers to the POS system 1524. In one example, the server(s) 1502 may include a merchant application and/or other functional components for communicating with the POS system 1524 and/or the server(s) 1508 to authorize or decline transactions (e.g., the API 1518). In examples, the seller platform 1510 can enable the merchants to receive cash payments, payment card payments, and/or electronic payments from customers for POS transactions and the service provider can process transactions on behalf of the merchants.

Based on the authentication notification that is received by the POS system 1524 from server(s) 1502, the merchant may indicate to the customer whether the transaction has been approved. In some examples, approval may be indicated at the POS system 1524, for example, at a display of the POS system 1524. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The seller platform 1510 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the user devices 1506 can access all of the services. In some cases, the user devices 1506 can have gradated access to the services, which can be based on risk tolerance, IDV outputs, subscriptions, and so on. In at least one example, access to such services can be availed to the merchants via the POS application 1520. In additional or alternative examples, each service can be associated with its own access point (e.g., application, web browser, etc.).

As the seller platform 1510 processes transactions on behalf of the merchants, the seller platform 1510 can maintain accounts or balances for the merchants in one or more ledgers. For example, the seller platform 1510 can analyze transaction data received for a transaction to determine an amount of funds owed to a merchant for the transaction and deposit funds into an account of the merchant. The account can have a stored balance, which can be managed by the seller platform 1510. The account can be different from a conventional bank account at least because the stored balance is managed by a ledger of the seller platform 1510 and the associated funds are accessible via various withdrawal channels including, but not limited to, scheduled deposit, same-day deposit, instant deposit, and a linked payment instrument.

A scheduled deposit can occur when the seller platform 1510 transfers funds associated with a stored balance of the merchant to a bank account of the merchant that is held at a bank or other financial institution (e.g., associated with the server(s) 1508). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the seller platform 1510 to the bank account of the merchant.

In at least one example, the seller platform 1510 may provide inventory management services. That is, the seller platform 1510 may provide inventory tracking and reporting. Inventory management services may enable the merchant to access and manage a database storing data associated with a quantity of each item that the merchant has available (i.e., an inventory). Furthermore, in at least one example, the seller platform 1510 can provide catalog management services to enable the merchant to maintain a catalog, which can be a database storing data associated with items that the merchant has available for acquisition (i.e., catalog management services). The seller platform 1510 can offer recommendations related to pricing of the items, placement of items on the catalog, and multi-party fulfillment of the inventory, to name a few examples.

In at least one example, the seller platform 1510 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the seller platform 1510 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the seller platform 1510 can provide financing services for offering and/or lending a loan to a borrower that is to be used for, in some instances, financing the borrower's short-term operational needs (e.g., a capital loan). Additionally or alternatively, the seller platform 1510 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The seller platform 1510 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The seller platform 1510 can provide web-development services, which enable users 1516 who are unfamiliar with HTML, XML, JavaScript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the seller platform 1510 can recommend and/or generate content items to supplement omni-channel presences of the merchants.

Furthermore, the seller platform 1510 can provide payroll services to enable employers to pay employees for work performed on behalf of employers. In at least one example, the seller platform 1510 can receive data that includes time worked by an employee (e.g., through imported timecards and/or POS interactions), sales made by the employee, gratuities received by the employee, and so forth. Based on such data, the seller platform 1510 can make payroll payments to employee(s) on behalf of an employer via the payroll service. For instance, the seller platform 1510 can facilitate the transfer of a total amount to be paid out for the payroll of an employee from the bank of the employer to the bank of the seller platform 1510 to be used to make payroll payments. In at least one example, when the funds have been received at the bank of the seller platform 1510, the seller platform 1510 can pay the employee, such as by check or direct deposit.

Moreover, in at least one example, the seller platform 1510 can provide employee management services for managing schedules of employees. Further, the seller platform 1510 can provide appointment services for enabling users 1516 to set schedules for scheduling appointments and/or users 1516 to schedule appointments.

In some examples, the seller platform 1510 can provide restaurant management services to enable users 1516 to make and/or manage reservations, to monitor front-of-house and/or back-of-house operations, and so on. In such examples, the seller device(s) 1506(A) and/or server(s) 1502 can be configured to communicate with one or more other computing devices, which can be located in the front-of-house (e.g., POS device(s)) and/or back-of-house (e.g., kitchen display system(s) (KDS)). In at least one example, the seller platform 1510 can provide order management services and/or fulfillment services to enable restaurants (or other merchant types) to manage open tickets, split tickets, and so on and/or manage fulfillment services.

In some examples, the seller platform 1510 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the seller platform 1510 can leverage other merchants and/or sales channels that are part of the seller platform 1510 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the seller platform 1510 can enable conversational commerce via conversational commerce services, which can use one or more machine learning mechanisms to analyze messages exchanged between two or more users 1516, voice inputs into a virtual assistant or the like, to determine intents of user(s) 1516. In some examples, the seller platform 1510 can utilize determined intents to automate customer service, offer promotions, provide recommendations, or otherwise interact with customers in real-time. In at least one example, the seller platform 1510 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1516 may be new to the seller platform 1510 such that the user 1516 that has not registered (e.g., subscribed to receive access to one or more services offered by the seller platform 1510) with the seller platform 1510. The seller platform 1510 can offer onboarding services for registering a potential user 1516 with the seller platform 1510. In some examples, onboarding can involve presenting various questions, prompts, and the like to a potential user 1516 to obtain information that can be used to generate a profile for the potential user 1516. In at least one example, the seller platform 1510 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the seller platform 1510 can be transitioned to more permissive (e.g., less limited) or longer-term access to such services.

The seller platform 1510 can be associated with IDV services, which can be used by the seller platform 1510 for compliance purposes and/or can be offered as a service, for instance to third-party service providers (e.g., associated with the server(s) 1508). That is, the seller platform 1510 can offer IDV services to verify the identity of users 1516 seeking to use or using their services. Identity verification may involve requesting a customer (or potential customer) to provide information that is used by compliance departments to prove that the information is associated with an identity of a real person or entity (e.g., an artist). In at least one example, the seller platform 1510 can perform services for determining whether identifying information provided by a user 1516 accurately identifies the customer (or potential customer).

Techniques described herein can be configured to operate in both real-time/online and offline modes. “Online” modes refer to modes when devices are capable of communicating with the seller platform 1510 while offline mode refers to modes when devices are unable to communicate with the server(s) 1508 due to network connectivity issue, for example. In such examples, devices may operate in “offline” mode where at least some payment data is stored (e.g., on the seller device(s) 1506(A)) and/or the server(s) 1502 until connectivity is restored and the payment data can be transmitted to the server(s) 1502 and/or the server(s) 1508 for processing.

In at least one example, the seller platform 1510 can be associated with a hub, such as an order hub, an inventory hub, a fulfillment hub and so on, which can enable integration with one or more additional service providers (e.g., associated with the additional server(s) 1508). In some examples, such additional service providers can offer additional or alternative services and the service provider can provide an interface or other computer-readable instructions to integrate functionality of the service provider into the one or more additional service providers.

Turning now to the P2P functionality provided by the environment 1500, the P2P platform 1512 can provide a peer-to-peer payment service that enables peer-to-peer payments between two or more of the users 1516. Two or more of the users 1516 may be considered “peers” in a peer-to-peer interaction, such as a payment. In at least one example, the P2P platform 1512 can communicate with instances of a payment application 1526 (or other access point) installed on end user devices 1506 configured for operation by the users 1516. In an example, an instance of the payment application 1526 executing on a first user device 1506(B) operated by a payor (e.g., one of the users 1516) can send a request to the P2P platform 1512 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1516) via a peer-to-peer payment. In some examples, assets associated with an account of the payor are transferred to an account of the payee. In some examples, assets can be held at least temporarily in an account of the P2P platform 1512 prior to transferring the assets to the account of the payee.

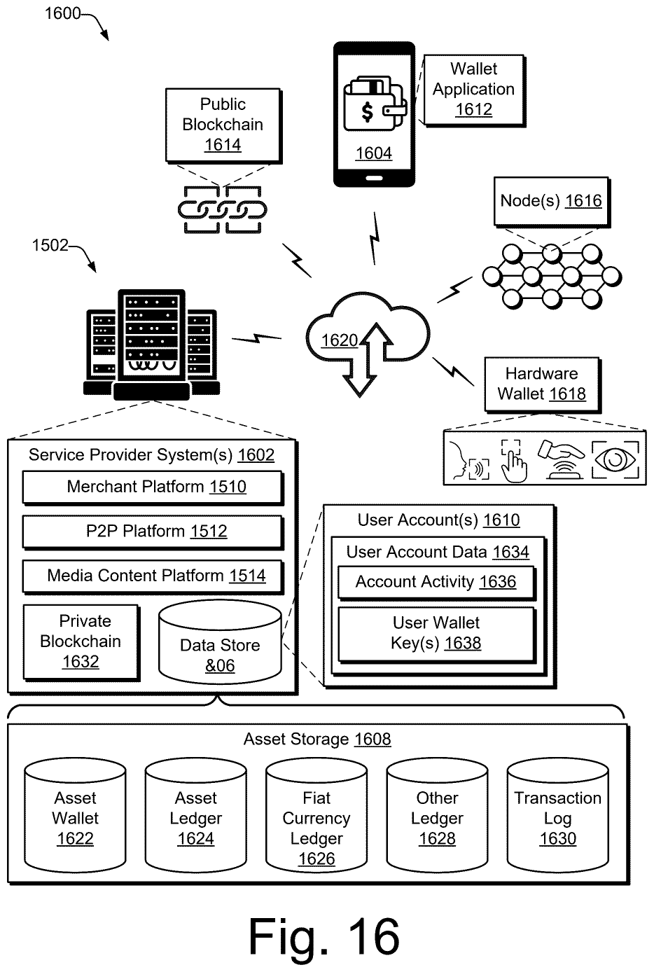

In some examples, the P2P platform 1512 can utilize a ledger system to track transfers of assets between users 1516. FIG. 16, below, provides additional details associated with such a ledger system. The ledger system can enable users 1516 to own fractional shares of assets that are not conventionally available. For instance, a user can own a fraction of a Bitcoin, an NFT, or a stock. Additional details are described herein.

In at least one example, the P2P platform 1512 can facilitate transfers and can send notifications related thereto to instances of the payment application 1526 executing on user device(s) of payee(s). As an example, the P2P platform 1512 can transfer assets from an account of a first user to an account of a second user and can send a notification to the user device 1506(B) of the second user for presentation via a user interface. The notification can indicate that a transfer is in process, a transfer is complete, or the like. In some examples, the P2P platform 1512 can send additional or alternative information to the instances of the payment application 1526 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1512 funds the request to payee on behalf of the payor, to speed up the transfer process and compensate for lags that may be attributed to the payor's financial network.

In some examples, the P2P platform 1512 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1502 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ) , yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 1526 executing on the end user devices 1506. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1512 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 15 or a third-party service provider associated with the server(s) 1508. In examples where the content provider is a third-party service provider, the server(s) 1508 can be accessible via one or more APIs 1518 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1512 (e.g., the P2P platform 1512 offers a chat or messaging service that is within the payment application or accessible via the payment application). In some examples, the messaging application can be external to the P2P platform 1512. (e.g., the messaging application is hosted by a third-party service provider associated with the server(s) 1508, which can be accessible via one or more of the APIs 1518 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1512 can enable users 1516 to perform banking transactions via instances of the payment application 1526. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 1512 can enable users to allocate funds between different accounts, sub-accounts, or balances (e.g., spending, saving, different assets, different currencies), etc. Further, users 1516 can configure bill pay, recurring payments, and/or the like using assets associated with their accounts. In some examples, the P2P platform 1512, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1512 enables users to buy and/or sell assets via asset networks such as cryptocurrency networks, securities networks, and/or the like. In some examples, acquisition of such assets can be in whole or fractional shares. The ledger system described below with reference to FIG. 16 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1512 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1512 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1512 can automatically apply the amount of funds associated with the gift card to the transaction.

In some examples, users can configure their account such that when they use their payment instruments, the P2P platform 1512 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1512 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1512 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1512 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1512.

In some examples, components of the environment 1500 may be integrated to enable payments at the point-of-sale using assets associated with user accounts of the P2P platform 1512. As illustrated in the environment 1500, the components can communicate with one another via the network 1504, where one or more APIs 1518 or other functional components can be used to facilitate such communication.

In at least one example, an integration can enable a customer to participate in a transaction via their own computing device (e.g., user device 1506(B)) instead of interacting with a merchant device of a merchant, such as the seller device 1506(A). In such an example, the POS application 1520, associated with a payment processing platform and executable by the seller device 1506(A) of the merchant, can present a Quick Response (QR) code, or other code that can be used to identify a transaction (e.g., a transaction code), in association with a transaction between the customer and the merchant. The QR code, or other transaction code, can be provided to the POS application 1520 via an API 1518 associated with the peer-to-peer payment platform. In an example, the customer can utilize their own computing device, such as the user device 1506(B), to capture the QR code, or the other transaction code, and to provide an indication of the captured QR code, or other transaction code, to server(s) 1502.

Based at least in part on the integration of the peer-to-peer payment platform and the payment processing platform (e.g., via the API 1518), the server(s) 1502 of the seller platform 1510 can exchange communications with a payment application 1526 associated with the P2P platform 1512 and/or the POS application 1520 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1512 and seller platform 1510 (which can be a first-or third-party integration) such that a QR code, or other transaction code, specific to the transaction can be used for providing transaction details, location details, customer details, or the like to a computing device of the customer, such as the user device 1506(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1506(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1520 and the payment application 1526, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1506(B), can be specially configured as a buyer-facing device having functionality similar to the functionality described above in the brick-and-mortar example.

In some examples, based at least in part on capturing the QR code, or other transaction code, the seller platform 1510 can provide transaction data to the P2P platform 1512 for presentation via the payment application 1526 on the computing device of the customer, such as the user device 1506B(B), to enable the customer to complete the transaction via their own computing device. In some examples, in response to receiving an indication that the QR code, or other transaction code, has been captured or otherwise interacted with via the customer computing device, the P2P platform 1512 can determine that the customer authorizes payment of the transaction using funds associated with a stored balance of the customer that is managed and/or maintained by the P2P platform 1512. Such authorization can be implicit such that the interaction with the transaction code can imply authorization of the customer. Alternatively or additionally, the P2P platform 1512 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 1512 can transfer funds from the stored balance of the customer to the seller platform 1510. In at least one example, the seller platform 1510 can deposit the funds, or a portion thereof, into a stored balance of the merchant that is managed and/or maintained by the seller platform 1510. In such an example, the seller platform 1510 can be a “peer” to the customer in a peer-to-peer transaction.

In some examples, techniques described herein can enable the customer to interact with the transaction after payment for the transaction has been settled. For example, in at least one example, the seller platform 1510 can cause a total amount of a transaction to be presented via a user interface associated with the payment application 1526 such that the customer can provide gratuity, feedback, loyalty information, or the like, via an interaction with the user interface. In another example, the seller platform 1510 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1512, if the customer inputs a tip and/or an event affecting the total amount of the transaction is triggered, the P2P platform 1512 can transfer additional funds, associated with the tip or event, to the seller platform 1510. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1526 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1512 as described herein (e.g., a debit card linked to a stored balance of a customer) such that when the payment instrument is caused to interact with a payment reader, the seller platform 1510 can exchange communications with the P2P platform 1512 to authorize payment for a transaction and/or provision associated transaction data to a computing device of the customer associated with the transaction.

Turning now to media content functionality provided by the environment 1500, the media content platform 1514 can provide digital media to a content consumption device 1506(D) where playback may occur using “streaming.” In examples, “streaming” media content involves encoding the media content and transmitting the encoded media content over the network 1504 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 1514 can provide a digital media streaming service (e.g., subscription-based, non-subscription-based) that enables a content consumption device 1506(D) to stream and/or download digital media content via a listener application 1528 installed on the content consumption device 1506(D). For instance, the media content platform 1514 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1506(D), the listener application 1528 may verify access rights to the digital media content items at time intervals, for instance intermittently (e.g., when the content consumption device 1506(D) has a network connection with the media content platform 1514 via the network(s) 1504), and/or at regular intervals (e.g., daily, weekly, monthly, etc.). In examples, access rights to the digital media content items may be provided when a subscription to the media content platform 1514 is active, while access rights to the digital media content items may be withheld when the subscription to the media content platform 1514 is terminated. Enabling storage on the end user devices 1506 and subsequent access to digital media content items via the listener application 1528 provides the users 1516 with the ability to access the digital media content items “offline” such as when a connection to the media content platform 1514 via the network(s) 1504 is unavailable or unreliable.

In some examples, the media content platform 1514 may additionally or alternatively provide an artist management service that enables the users 1516 to manage aspects of artist business via an artist application 1530 installed on the artist device 1506(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1516 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 1516 may have access to a single user account via respective end user devices 1506, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1530 and the listener application 1528 may be distinct applications having differing user experiences and verification processes for access, such as illustrated in the environment 1500. For instance, the media content platform 1514 may request additional verification, such as a link to an artist website, a sample of an artist's work, a verified credential supplied by a third party, etc. to grant access to the artist application 1530 in addition to information requested to access the listener application 1528. Further, the artist application 1530 may provide the artist management services described herein, without the subscription-based digital media streaming services described herein, and vice versa. However, examples are also considered in which functionality provided by the artist application 1530 and the listener application 1528 partially or fully overlap, and/or where verification processes for access are substantially similar.

In at least some examples, the media content platform 1514 enables interaction between the users 1516 utilizing the listener application 1528 installed on the content consumption devices 1506(D), and the users 1516 utilizing the artist application 1530 installed on the artist devices 1506(E). For example, the media content platform 1514 may provide interconnectivity between the subscription-based digital media streaming service and the artist management service. Functionality provided by the media content platform 1514 in such instances may include a communication channel between one or more of the users 1516 (e.g., a listener, fan, music supervisor, publisher, etc.) utilizing the listener application 1528 and another user (e.g., an artist) of the users 1516 utilizing the artist application 1530. The communication channel may include, for instance, a messaging platform (also referred to as a “messaging application” herein), a live streaming platform, a videoconferencing or teleconferencing platform, and/or a combination of these.

Additionally, in some cases, the media content platform 1514 may facilitate a resource transfer between the listener application 1528 and the artist application 1530. In an example, the media content platform 1514 may direct a resource, such as a portion of a subscription fee paid by one of the users 1516 designated as a listener, to one or more of the users 1516 designated as artists based on a number of instances that the listening user consumed (e.g., streamed, downloaded, etc.) content created by respective ones of the artist users. Alternatively or additionally, the media content platform 1514 may direct a resource, such as funds, from an account associated with a listening user to an account associated with an artist user (or vice versa), in accordance with transfers between accounts as described herein. The media content platform 1514 may facilitate resource transfers in examples such as merchandise purchases, event ticket purchases, “tipping” an artist, payments for royalties or other fees, and so forth.

In some examples, the media content platform 1514 enables interaction between individual ones of the users 1516 with one another via the listener application 1528 installed on the content consumption device 1506(D) and other of the content consumption devices 1506(D) via a communication channel as described above. In an example, the listener application 1528 may provide functionality via a communication channel for a user to stream an individual digital media item, a playlist, or the like to an audience comprising other ones of the content consumption devices 1506(D). Alternatively or additionally, the communication channel may facilitate sharing of individual digital media items, playlists, user and/or artist profiles, and the like between the users 1516 via messages, uniform resource locators (URLs), quick response (QR) codes, and so forth.

In some cases, the media content platform 1514 enables interaction between individual ones of the users 1516 with one another via the artist application 1530 installed on the artist device 1506(E) and other of the artist devices 1506 via a communication channel as described above. In some instances, the media content platform 1514 may provide recommendations for a particular user indicating which of the other users 1516 to communicate with. Such a recommendation may be based on a similarity (or dissimilarity) of content created by two or more of the users 1516, an overlap (or lack thereof) of audience members of the users 1516, a geographic location of the users 1516, a coinciding event location of the users 1516, and so forth. In some examples, a user may input parameters for a desired connection via the artist application 1530, and the media content platform 1514 may filter which of the users 1516 to surface for recommendations to the user based on the input parameters. Alternatively or additionally, the media content platform 1514 may implement one or more machine learning models to filter which of the users 1516 to surface for recommendations to the user. The recommendations provided by the media content platform 1514 may be data driven and thus increase relevance of communications presented to the users 1516 and reduce unsolicited communications that may be received by the users 1516.

The media content platform 1514 may interact with the server(s) 1508 associated with the third-party service providers to, for instance, ingest digital media items, report digital media consumption data, pay royalties, and the like. In some examples, the server(s) 1508 may be accessible by the media content platform 1514 via one or more APIs 1518 or other integrations. In some cases, the third-party service provider may be a digital media content provider (e.g., a record label, a performance rights organization (PRO), an independent artist, etc.). In such cases, the media content platform 1514 may receive digital media content items from the server(s) 1508, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 1514 may use the metadata to associate the digital media content item as being created by a particular user, to provide search results to the users 1516, to generate playlists, and so forth. Further, the media content platform 1514 may provide payments (e.g., royalties) to the third-party service provider based on a number of streams and/or downloads of individual digital media content items by the users via the listener application 1528.

Techniques described herein are directed to services provided via a distributed system of end user devices 1506 that are in communication with server(s) 1502 of the service provider. That is, techniques described herein are directed to a specific implementation—or, a practical application—of utilizing a distributed system of end user devices 1506 that are in communication with server(s) 1502 of the seller platform 1510, the P2P platform 1512, and/or the media content platform 1514 to perform a variety of services, as described above. The unconventional configuration of the distributed system described herein enables the server(s) 1502 that are remotely-located from end-users (e.g., users 1516) to intelligently offer services based on aggregated data associated with the end-users, such as the users 1516 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the seller platform 1510, the P2P platform 1512, and/or the media content platform 1514, and those outside of the control of these service providers, to track the standing (payables, receivables, payroll, invoices, appointments, capital, balances, collaborations, etc.) of the users 1516. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1516 and end user devices 1506. Furthermore, such features are changed dynamically based on the profiles of the users involved interacting with the GUIs. As such, techniques described herein are directed to improvements to computing systems.

The seller platform 1510, the P2P platform 1512, and/or the media content platform 1514 are capable of providing additional or alternative services, and the services described above are offered as a sampling of services. In at least one example, the seller platform 1510, the P2P platform 1512, and/or the media content platform 1514 can exchange data with the server(s) 1508 associated with third-party service providers. Such third-party service providers can provide information that enables the seller platform 1510, the P2P platform 1512, and/or the media content platform 1514 to provide services, such as those described above. In additional or alternative examples, such third-party service providers can access services of the seller platform 1510, the P2P platform 1512, and/or the media content platform 1514. That is, in some examples, the third-party service providers can be subscribers, or otherwise access, services of the seller platform 1510, the P2P platform 1512, and/or the media content platform 1514.

FIG. 16 illustrates an example environment 1600 including a service provider system 1602 which may be associated with the server(s) 1502 of FIG. 15. The environment 1600 may also include a user device 1604, which may correspond to any of the end user devices 1506 described in relation to FIG. 15. In examples, the service provider system 1602 may include one or a combination of the seller platform 1510, the P2P platform 1512, or the media content platform 1514, as well as one or more data store(s) 1606 that can store assets in an asset storage 1608, as well as data in user account(s) 1610. In some examples, the environment 1600 may also include a public blockchain 1614, one or more nodes 1616, and/or a hardware wallet 1618. The service provider system 1602, the user device 1604, public blockchain 1614, the node(s) 1616, and the hardware wallet 1618 may be connected and able to communicate via one or more networks 1620, which may have the same or similar functionality described in relation to the network 1504 of FIG. 15.

In some examples, user account(s) 1610 can include merchant account(s), customer account(s), media content subscriber account(s), artist account(s), and so forth. In at least one example, the asset storage 1608 can be used to record whether individual assets are registered to a user account 1610. For example, the asset storage 1608 can include asset wallet(s) 1622 for storing records of assets owned by the service provider system 1602, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 1508 of FIG. 15 can be associated therewith.

The asset wallet 1622 can be associated with one or more addresses and can vary addresses used to acquire assets (e.g., from the asset network(s)) so that its holdings are represented under a variety of addresses on the asset network. In examples where the service provider system 1602 has holdings of cryptocurrency (e.g., in the asset wallet 1622), a user can acquire cryptocurrency directly from the service provider system 1602. In some examples, the service provider system 1602 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 1602 can provide the same or similar functionality for securities or other assets.

The asset storage 1608 may contain ledgers that store records of assignments of assets to users 1516. Specifically, the asset storage 1608 may include asset ledger 1624, fiat currency ledger 1626, and/or other ledger(s) 1628, which can be used to record transfers of assets between users 1516 and/or one or more third-parties (e.g., merchant network(s), payment card network(s), ACH network(s), equities network(s), the asset network, securities networks, etc.). In doing so, the asset storage 1608 can maintain a running balance of assets managed by the service provider system 1602. The ledger(s) of the asset storage 1608 can further indicate some of the running balance for individual ledger(s) stored in the asset storage 1608 are assigned or registered to one or more user account(s) 1610.

In at least one example, the asset storage 1608 can include transaction logs 1630, which can include, as transaction data, records of past transactions involving the service provider system 1602 and/or the user account 1610. In some examples, the data store(s) 1606 can store a private blockchain 1632. A private blockchain 1632 can function to record sender addresses, recipient addresses, public keys, values of cryptocurrency transferred, and/or can be used to verify ownership of cryptocurrency tokens to be transferred. In some examples, the service provider system 1602 can record transactions involving cryptocurrency until the number of transactions has exceeded a determined limit (e.g., number of transactions, storage space allocation, etc.). Based at least in part on determining that the limit has been reached, the service provider system 1602 can publish the transactions in the private blockchain 1632 to the public blockchain 1614 (e.g., associated with the asset network), where miners can verify the transactions and record the transactions to blocks on the public blockchain 1614. In at least one example, the service provider system 1602 can participate as miner(s) at least for transactions to which the respective platform is a party to, to be posted to the public blockchain 1614.

In some cases, the data store(s) 1606 can store and/or manage multiple user accounts, an example of which is described in relation to the user account 1610. In at least one example, the user account 1610 can include user account data 1634, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1634 can include account activity 1636 and user wallet key(s) 1638. In some examples, the user wallet key(s) 1638 can include a public-private key-pair and a respective address associated with the asset network or other asset networks. In some examples, the user wallet key(s) 1638 may include one or more key pairs, which can be unique to the asset network or other asset networks.

In addition to the user account data 1634, the user account 1610 can include ledger(s) for account(s) managed by the service provider system 1602, for the user. For example, the user account 1610 may include an asset ledger 1624, a fiat currency ledger 1626, and/or one or more other ledgers 1628. The ledger(s) can indicate that a corresponding user utilizes the service provider system 1602 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 1602.

In some examples, the asset ledger 1624 can store a balance for each of one or more cryptocurrencies (e.g., Bitcoin, Ethereum, Litecoin, etc.) registered to the user account 1610. In at least one example, the asset ledger 1624 can further record transactions of cryptocurrency assets associated with the user account 1610. For example, the user account 1610 can receive cryptocurrency from the asset network using the user wallet key(s) 1638. In some examples, the user wallet key(s) 1638 may be generated for the user upon request. User wallet key(s) 1638 can be requested by the user in order to send, exchange, or otherwise control the balance of cryptocurrency held by the service provider system 1602 (e.g., in the asset wallet 1622) and registered to the user. In some examples, the user wallet key(s) 1638 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 1602 and the value is credited as a balance in asset ledger 1624), by purchasing currency in the form associated with the account using currency in a different form (e.g., buying a value of cryptocurrency from the service provider system 1602 using a value of fiat currency reflected in fiat currency ledger 1626, and crediting the value of cryptocurrency in asset ledger 1624), or by conducting a transaction with another user (customer or merchant) of the service provider system 1602 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 1602 (i.e., an external account). Such a transaction can request that the user to transfer an amount of the cryptocurrency in a message signed by user's private key to an address provided by the service provider system 1602. In at least one example, the transaction can be sent to miners to bundle the transaction into a block of transactions and to verify the authenticity of the transactions in the block. Once a miner has verified the block, the block is written to the public blockchain 1614 where the service provider system 1602 can then verify that the transaction has been confirmed and can credit the user's asset ledger 1624 with the transferred amount. When an account is funded by transferring cryptocurrency from a third-party cryptocurrency wallet, an update can be made to the public blockchain 1614. In some cases, this update of the public blockchain 1614 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 1602. As described above, in some examples, the service provider system 1602 can acquire cryptocurrency from a third-party source. In examples where the service provider system 1602 has its own cryptocurrency assets, cryptocurrency transferred in a transaction (e.g., data with address provided for receipt of transaction and a balance of cryptocurrency transferred in the transaction) can be stored in an asset wallet 1622 associated with the service provider system 1602. In at least one example, the service provider system 1602 can credit the asset ledger 1624 of the user. Additionally, while the service provider system 1602 recognizes that the user retains the value of the transferred cryptocurrency through crediting the asset ledger 1624, an inspection of the blockchain will show the cryptocurrency as having been transferred to the service provider system 1602. In some examples, the asset wallet 1622 can be associated with many different addresses. In such examples, an inspection of the blockchain may not necessarily associate all cryptocurrency stored in asset wallet 1622 as belonging to the same entity. The presence of a private ledger used for real-time transactions and maintained by the service provider system 1602, combined with updates to the public ledger at other times, allows for extremely fast transactions using cryptocurrency to be achieved. In some examples, the “private ledger” can refer to the asset ledger 1624, which in some examples, can utilize the private blockchain 1632, as described herein. The “public ledger” can correspond to the public blockchain 1614 associated with the asset network.

In at least one example, an asset ledger 1624, fiat currency ledger 1626, or the like associated with the user account 1610 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1624. In some examples, a user can receive fiat currency or another currency in the form of payment for a transaction with another user. In at least one example, at least a portion of such funds can be converted into cryptocurrency by the service provider system 1602 and used to fund the asset ledger 1624 of the user.

In examples, a user can also have an account in U.S. dollars, which can be tracked, for example, via the fiat currency ledger 1626. Such an account can be funded by transferring money from a bank account at a third-party bank to an account maintained by the service provider system 1602 as is conventionally known. In some examples, a user can receive fiat currency in the form of payment for a transaction with another user. In such examples, at least a portion of such funds can be used to fund the fiat currency ledger 1626.

In some examples, a user can have one or more internal payment cards registered with the service provider system 1602. Internal payment cards can be linked to one or more of the accounts associated with the user account 1610. In some embodiments, options with respect to internal payment cards can be adjusted and managed using an application (e.g., the payment application 1526, a wallet application 1612, etc.).

In at least one example, the user account 1610 can be associated with the asset wallet accessible via a wallet application 1612 of the user device 1604, or a stored balance for use in payment transactions, peer-to-peer transactions, payroll payments, etc. In at least one example, the asset wallet 1622 can store data indicating an address provided for receipt of a cryptocurrency transaction. In at least one example, the balance of the asset wallet 1622 can be based at least in part on a balance of the asset ledger 1624. In at least one example, funds availed via the asset wallet 1622 can be stored in the asset wallet 1622. Funds availed via the asset wallet 1622 can be tracked via the asset ledger 1624. The asset wallet 1622, however, can be associated with additional cryptocurrency funds.

In at least one example, when the service provider system 1602 includes a private blockchain 1632 for recording and validating cryptocurrency transactions, the asset wallet 1622 can be used instead of, or in addition to, the asset ledger 1624. For example, a merchant can provide the address of the asset wallet 1622 for receiving payments. In an example where a customer is paying in cryptocurrency and the customer has their own cryptocurrency wallet account associated with the service provider system 1602, the customer can send a message signed by its private key including its wallet address (i.e., of the customer) and identifying the cryptocurrency and value to be transferred to the merchant's asset wallet 1622. The service provider system 1602 can complete the transaction by reducing the cryptocurrency balance in the customer's cryptocurrency wallet and increasing the cryptocurrency balance in the merchant's asset wallet 1622. In addition to recording the transaction in the respective cryptocurrency wallets, the transaction can be recorded in the private blockchain 1632 and the transaction can be confirmed. A user can perform a similar transaction with cryptocurrency in a peer-to-peer transaction as described above.

While the asset ledger 1624 and/or asset wallet 1622 are each described above with reference to cryptocurrency, the asset ledger 1624 and/or asset wallet 1622 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 1602 is an aspect of the technology disclosed that enables technical advantages of increased processing speed and improved security.

The description of the environment 1600 above generally relates to a centralized service provider that at least partially facilitates storing and managing assets in the data store 1606. However, the environment 1600 may also facilitate decentralized storage and management of assets alternatively or in addition to centralized storage and management as described above. For instance, the environment 1600 may include a decentralized platform implemented using a plurality of nodes (e.g., web nodes), an example of which is illustrated as node 1616. The node 1616 is representative of a computer or other device tasked with validating transactions and/or maintaining a copy of a blockchain ledger, such as a ledger associated with the public blockchain 1614. The decentralized platform may be implemented via the environment 1600 through use of decentralized identifiers and verifiable credentials that are stored and managed by user devices 1604. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 1602). The decentralized identity referenced by a decentralized identifier gives an entity control over what data can be accessed, stored, modified, and so forth by other entities, such as the service provider system 1602.

The node 1616, as representative of one of a plurality of decentralized nodes (e.g., decentralized web nodes), supports data storage and relays that allows entities, service provider systems, individuals, organizations and so forth to send, store, and receive encrypted or public messages and data. The node 1616 is universally addressable and is “crawlable” using data addressing in relation to the decentralized identifiers. The node 1616 is also configured to support decentralized replication of data across the nodes that is consistent across multiple nodes over time through continued data communication between the nodes in the decentralized platform. The node 1616 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 1604 may be an issuer, a holder, and/or a verifier, as can the service provider system 1602.

In some examples, the user device 1604 may implement a wallet application 1612 configured to manage decentralized identifiers and/or verifiable credentials. For instance, the wallet application 1612 may provide a user interface for implementation of access controls to various data associated with the decentralized identifier by the service provider system 1602, to other user devices, and so forth. Additionally, the wallet application 1612 may be configured to provide functionality for resource transfers (e.g., cryptocurrency, fiat currency, etc.) with the service provider system 1602, other user devices, and the like, based on techniques described herein.

In some examples, the hardware wallet 1618 may store cryptocurrency assets in combination with the wallet application 1612 and the service provider system 1602. For instance, the hardware wallet 1618, the wallet application 1612, and the service provider system 1602 may each store a respective, different private key, where a transaction with the cryptocurrency assets is signed by at least two of the three private keys. The user interface provided by the wallet application 1612 may allow a user to request a transaction. The wallet application 1612 may then sign the transaction with the private key of the wallet application 1612, have either the hardware wallet 1618 or the service provider system 1602 use a second of the three private keys to sign the transaction, and then provide the transaction with two signatures to the public blockchain 1614 for processing.

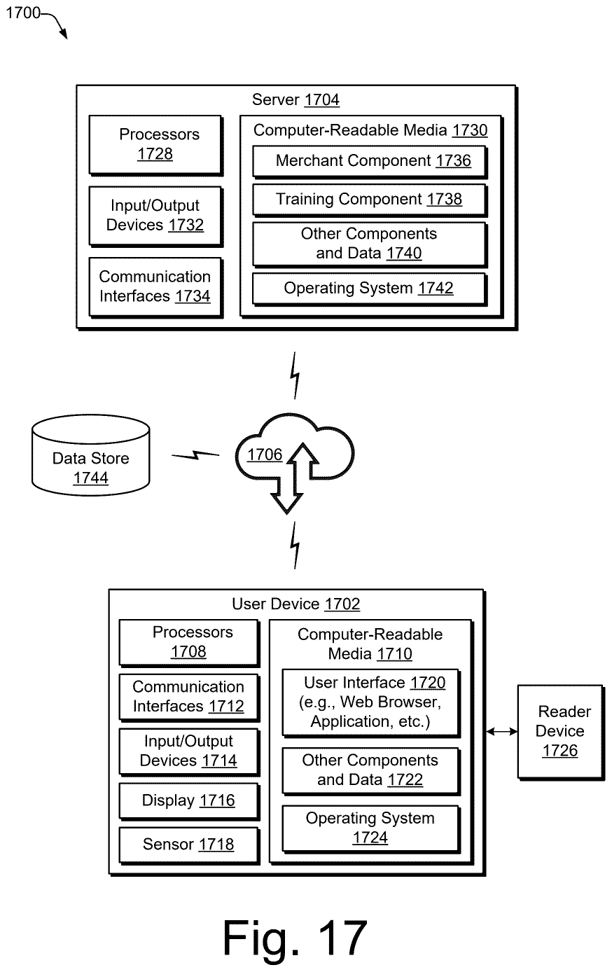

FIG. 17 depicts an illustrative block diagram illustrating a system 1700 for performing techniques described herein. The system 1700 includes a user device 1702, that communicates with server computing device(s) (e.g., server(s) 1704) via network(s) 1706 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1702 is illustrated, in additional or alternate examples, the system 1700 can have multiple user devices, as described above with reference to FIG. 15 and shown in FIGS. 4-6, 8-10.

In at least one example, the user device 1702 can be any suitable type of computing device, e.g., portable, semi-portable, semi-stationary, or stationary. Some examples of the user device 1702 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 1702 can be any computing device capable of sending communications and performing the functions according to the techniques described herein. The user device 1702 can include devices, e.g., payment card readers, or components capable of accepting payments, as described below. The user device 1702 may be representative of, and provide functionality for, the user devices 1506 described in relation to FIG. 15.

In the illustrated example, the user device 1702 includes one or more processors 1708, one or more computer-readable media 1710, one or more communication interface(s) 1712, one or more input/output (I/O) devices 1714, a display 1716, and sensor(s) 1718. The user device 1702 is also configurable to include one or more encoders and one or more decoders.

In at least one example, each processor 1708 can itself comprise one or more processors or processing cores. For example, the processor(s) 1708 can be implemented as one or more microprocessors, microcomputers, microcontrollers, digital signal processors, central processing units, state machines, logic circuitries, and/or any devices that manipulate signals based on operational instructions. In some examples, the processor(s) 1708 can be one or more hardware processors and/or logic circuits of any suitable type specifically programmed or configured to execute the algorithms and processes described herein. The processor(s) 1708 can be configured to fetch and execute computer-readable processor-executable instructions stored in the computer-readable media 1710.

Depending on the configuration of the user device 1702, the computer-readable media 1710 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1710 can include, but is not limited to, RAM, ROM, EEPROM, flash memory, solid-state storage, magnetic disk storage, optical storage, and/or other computer-readable media technology. Further, in some examples, the user device 1702 can access external storage, such as RAID storage systems, storage arrays, network attached storage, storage area networks, cloud storage, or any other medium that can be used to store information and that can be accessed by the processor(s) 1708 directly or through another computing device or network. Accordingly, the computer-readable media 1710 can be computer storage media able to store instructions, components or components that can be executed by the processor(s) 1708. Further, when mentioned, non-transitory computer-readable media exclude media such as energy, carrier signals, electromagnetic waves, and signals per se.

The computer-readable media 1710 can be used to store and maintain any number of functional components that are executable by the processor(s) 1708. In some implementations, these functional components comprise instructions or programs that are executable by the processor(s) 1708 and that, when executed, implement operational logic for performing the actions and services attributed above to the user device 1702. Functional components stored in the computer-readable media 1710 can include a user interface 1720 to enable users to interact with the user device 1702, and thus the server(s) 1704 and/or other networked devices. In at least one example, a user can interact with the user interface via touch input, spoken input, gesture, or any other type of input as shown in FIGS. 4-6, 8-10. The word “input” is also used to describe “contextual” input that may not be directly provided by the user via the user interface 1720. For example, user's interactions with the user interface 1720 are analyzed using, e.g., natural language processing techniques, user movement tracking techniques, eye tracking techniques, etc. to determine context or intent of the user, which may be treated in a manner similar to “direct” user input.

Depending on the type of the user device 1702, the computer-readable media 1710 can also optionally include other functional components and data, such as other components and data 1722, which can include programs, drivers, etc., and the data used or generated by the functional components. In addition, the computer-readable media 1710 can also store data, data structures and the like, that are used by the functional components. Further, the user device 1702 can include many other logical, programmatic and physical components, of which those described are merely examples that are related to the discussion herein.

In at least one example, the computer-readable media 1710 can include additional functional components, such as an operating system 1724 for controlling and managing various functions of the user device 1702 and for enabling user interactions.

The communication interface(s) 1712 can include one or more interfaces and hardware components for enabling communication with various other devices, such as over the network(s) 1706 or directly. For example, communication interface(s) 1712 can enable communication through one or more network(s) 1706, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1706 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1702 can further include one or more input/output (I/O) devices 1714. The I/O devices 1714 can include speakers, a microphone, a camera, and various user controls (e.g., buttons, a joystick, a keyboard, a keypad, etc.), a haptic output device, and so forth. The I/O devices 1714 can also include attachments that leverage the accessories (audio-jack, USB-C, Bluetooth, etc.) to connect with the user device 1702.

In at least one example, user device 1702 can include a display 1716. Depending on the type of computing device(s) used as the user device 1702, the display 1716 can employ any suitable display technology. For example, the display 1716 can be a liquid crystal display, a plasma display, a light emitting diode display, an OLED (organic light-emitting diode) display, an electronic paper display, or any other suitable type of display able to present digital content thereon. In at least one example, the display 1716 can be an augmented reality display, a virtual reality display, or any other display able to present and/or project digital content. In some examples, the display 1716 can have a touch sensor associated with the display 1716 to provide a touchscreen display configured to receive touch inputs for enabling interaction with a graphic interface presented on the display 1716. Accordingly, implementations herein are not limited to any particular display technology. In some examples, the user device 1702 may not include the display 1716, and information can be presented by other means, such as aurally, haptically, etc.

In addition, the user device 1702 can include sensor(s) 1718. The sensor(s) 1718 can include a global positioning system (“GPS”) device able to indicate location information. Further, the sensor(s) 1718 can include, but are not limited to, an accelerometer, gyroscope, compass, proximity sensor, camera, microphone, and/or a switch.

In some examples, the GPS device can be used to identify a location of a user. In at least one example, the location of the user can be used by the seller platform 1510, the P2P platform 1512, and/or the media content platform 1514, described above, to provide one or more services. That is, in some examples, the service provider can implement geofencing to provide particular services to users by the seller platform 1510, the P2P platform 1512, and/or the media content platform 1514.

In examples, the user device 1702 includes a codec system, which may comprise an encoder and/or a decoder. The encoder is configured to encode a data stream or signal from an analog signal (e.g., an analog audio signal, an analog video signal, etc.) to a digital signal for transmission or storage. The decoder is configured to convert the digital signal back to an analog signal, such as for playback or editing. In some cases, the encoder may be configured to encode the data stream or analog signal in an encrypted format, and the decoder may accordingly be configured to decrypt the digital signal as part of the decoding process (e.g., using a cryptographic key). Additionally, in some examples, the encoder may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder and/or the decoder may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 1700, the server 1704 may include an encoder and/or a decoder as well.

Additionally, the user device 1702 can include various other components that are not shown, examples of which include removable storage, a power source, such as a battery and power control unit, a barcode scanner, a printer, a cash drawer, and so forth.

In addition, as described in relation to FIG. 15, the user device 1702 can include, be connectable to, or otherwise be coupled to a reader device 1726, for reading payment instruments and/or identifiers associated with payment objects. The reader device 1726 can include a read head for reading a magnetic strip of a payment card, and further can include encryption technology for encrypting the information read from the magnetic strip. Additionally or alternatively, the reader device 1726 can be an EMV payment reader, which in some examples, can be embedded in the user device 1702. Moreover, numerous other types of readers can be employed with the user device 1702 herein, depending on the type and configuration of the user device 1702.

The reader device 1726 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 1726 may include hardware implementation, such as slots, magnetic tracks, and rails with one or more sensors or electrical contacts to facilitate detection and acceptance of a payment instrument. That is, the reader device 1726 may include hardware implementations to enable the reader device 1726 to interact with a payment instrument via a swipe, a dip, or a tap to obtain payment data associated with a customer. Additionally or optionally, the reader device 1726 may also include a biometric sensor to receive and process biometric characteristics and process them as payment instruments, given that such biometric characteristics are registered with the payment service and connected to a financial account with a bank server. The reader device 1726 may include processing unit(s), computer-readable media, a reader chip, a transaction chip, a timer, a clock, a network interface, a power supply, and so on. That is, the reader device 1726 may include any of the computing components described herein with reference to the user device 1702 to implement the functionality provided by the reader device 1726.

In examples, the reader device 1726 includes a reader chip, which may perform functionality to control the power supply, among other functionality of the reader device 1726. The power supply may include one or more power supplies such as a physical connection to AC power or a battery. Power supply may include power conversion circuitry for converting AC power and generating a plurality of DC voltages for use by components of reader device 1726. When power supply includes a battery, the battery may be charged via a physical power connection, via inductive charging, or via any other suitable method.

The reader device 1726 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1702, which can be a POS terminal, and the reader device 1726 are shown as separate devices, in additional or alternative examples, the user device 1702 and the reader device 1726 can be part of a single device, which may be a battery-operated device. In some examples, the reader device 1726 can have a display integrated therewith, which can be in addition to (or as an alternative of) the display 1716 associated with the user device 1702.

The server(s) 1704 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1704 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1704 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1704 can include one or more processors 1728, one or more computer-readable media 1730, one or more I/O devices 1732, and one or more communication interfaces 1734. Each processor 1728 can be a single processing unit or a number of processing units and can include single or multiple computing units or multiple processing cores. The processor(s) 1728 can be implemented as one or more microprocessors, microcomputers, microcontrollers, digital signal processors, central processing units, state machines, logic circuitries, and/or any devices that manipulate signals based on operational instructions. For example, the processor(s) 1728 can be one or more hardware processors and/or logic circuits of any suitable type specifically programmed or configured to execute the algorithms and processes described herein. The processor(s) 1728 can be configured to fetch and execute computer-readable instructions stored in the computer-readable media 1730, which can program the processor(s) 1728 to perform the functions described herein.

The computer-readable media 1730 can include volatile and nonvolatile memory and/or removable and non-removable media implemented in any type of technology for storage of information, such as computer-readable instructions, data structures, program components, or other data. Such computer-readable media 1730 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1704, the computer-readable media 1730 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1730 can be used to store any number of functional components that are executable by the processor(s) 1728. In many implementations, these functional components comprise instructions or programs that are executable by the processors 1728 and that, when executed, specifically configure the one or more processors 1728 to perform the actions attributed above to the seller platform 1510, the P2P platform 1512, and/or the media content platform 1514. Functional components stored in the computer-readable media 1730 can optionally include a merchant component 1736, a training component 1738, and one or more other components and data 1740. The computer-readable media 1730 can additionally include an operating system 1742 for controlling and managing various functions of the server(s) 1704.

The merchant component 1736 can be configured to receive transaction data from POS systems, such as the POS system 1524 described above with reference to FIG. 15. The merchant component 1736 can transmit requests (e.g., authorization, capture, settlement, etc.) to payment service server computing device(s) to facilitate POS transactions between merchants and customers. The merchant component 1736 can communicate the successes or failures of the POS transactions to the POS systems.

The training component 1738 can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1702 and/or the server(s) 1704 for use at a time after the data models have been trained (e.g., at runtime).

The one or more other components and data 1740 can include functionality of which is described above. Further, the one or more other components and data 1740 can include programs, drivers, etc., and the data used or generated by the functional components. Further, the server(s) 1704 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 1734 can include one or more interfaces and hardware components for enabling communication with various other devices, such as over the network(s) 1706 or directly. For example, communication interface(s) 1734 can enable communication through one or more network(s) 1706, which can include, but are not limited any type of network known in the art, as described herein.

The server(s) 1704 can further be equipped with various I/O devices 1732. Such I/O devices 1732 can include a display, various user interface controls (e.g., buttons, joystick, keyboard, mouse, touch screen, biometric or sensory input devices, etc.), audio speakers, connection ports and so forth.

In at least one example, the system 1700 can include a datastore 1744 that can be configured to store data that is accessible, manageable, and updatable. In some examples, the datastore 1744 can be integrated with the user device 1702 and/or the server(s) 1704. In other examples, as shown in FIG. 17, the datastore 1744 can be located remotely from the server(s) 1704 and can be accessible to the server(s) 1704. The datastore 1744 can comprise multiple databases and/or servers connected locally and/or remotely via the network(s) 1706. In at least one example, the datastore 1744 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 1744 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1744 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
receiving, by a local hub synchronization system, a first communication from a first edge device and a second communication from a second edge device,
detecting, by the local hub synchronization system, a conflict involving the first and second communications;
inferring a first intent from the first communication and a second intent from the second communication;
implementing, by the local hub synchronization system, a conflict resolution module to resolve the conflict between the first communication and the second communication based on the first intent from the first communication and the second intent from the second communication;
generating, by the local hub synchronization system, a resolved communication based on application of the conflict resolution module;
updating, at the local hub synchronization system, a local database of the local hub synchronization system with the resolved communication;
transmitting, by the local hub synchronization system, the resolved communication to the first and second edge devices to synchronize respective local databases; and
transmitting, by the local hub synchronization system, the resolved communication via a network to a remote hub synchronization system to indicate the resolved communication as involving the first and second communications.

2. The method as described in claim 1, wherein the detecting the conflict is based at least in part on a timestamp comparison, content analysis, user identity verification, order status check, rule-based conflict detection, or by a machine-learning model.

3. The method as described in claim 1, wherein the inferring the first intent from the first communication and the second intent from the second communication is based on natural language processing (NLP), contextual analysis, behavioral patterns, a machine-learning model, or sentiment analysis.

4. The method as described in claim 1, wherein the conflict resolution module is based on a set of rules as applied the first and second intent and the first and second communications.

5. The method as described in claim 1, wherein the conflict resolution module is based on one or more heuristics as applied the first and second intent and the first and second communications.

6. The method as described in claim 1, wherein the conflict resolution module is based on artificial intelligence as implemented by one or more machine-learning models based on the first and second intent and the first and second communications.

7. The method as described in claim 1, wherein the conflict resolution module is based on a user input received responsive to the conflict.

8. The method as described in claim 1, wherein the conflict resolution module employs prioritization based on timestamp-based resolution, rule-based conflict resolution, a user input received via a user interface, or is automated using at least one machine-learning model.

9. The method as described in claim 1, wherein the first communication and the second communications involve transaction processing, order management, inventory management, customer engagement, receipts, computing device operation, or invoices.

10. The method as described in claim 1, wherein the local hub synchronization system is executed by the first edge device or the second edge device.

11. The method as described in claim 1, wherein the first and second edge devices are communicatively coupled to the local hub synchronization system via Wi-Fi and the local hub synchronization system is communicatively coupled to the service provider system via an Internet connection.

12. The method as described in claim 1, wherein the local database of the local hub synchronization system is configured to cache the resolved communication for subsequent communication upon detecting availability of a communicative coupling with the service provider system, the first edge device, or the second edge device.

13. A method comprising:
forming a communicative coupling with at least one application programming interface of a remote hub synchronization system by an edge device of a plurality of edge devices disposed at an establishment;
receiving communications from one or more of the plurality of edge devices at the establishment having conflicts managed using the remote hub synchronization system;
installing a local hub synchronization system at the establishment;
managing communication conflicts of the plurality of edge devices using the local hub synchronization system;
detecting inaccessibility of the local hub synchronization system by at least one edge device; and
automatically falling back to the management of the communication conflicts with the remote hub synchronization system by at least one edge device responsive to the detecting.

14. The method as described in claim 13, wherein the installing includes installing software on a respective said edge device that is executable on the respective said edge device to implement the local hub synchronization system.

15. The method as described in claim 13, wherein the installing includes installing a local hub synchronization device within the establishment as communicatively coupled to the plurality of edge devices, the local hub synchronization device having software that is executable to implement the local hub synchronization system.

16. The method as described in claim 13, wherein the installing includes forming a communicative coupling of the local hub synchronization system with the plurality of edge devices.

17. The method as described in claim 16, wherein the detecting the inaccessibility includes detecting failure of a respective said communicative coupling formed with the local hub synchronization system.

18. A method for edge device communication synchronization, the method comprising:
receiving, by a local hub synchronization system, a first communication from a first edge device and a second communication from a second edge device, in which the first and second communications have a common data structure;
extracting a context associated with the first and second communications, the context including at least one of a timestamp of the transaction update, a device type identifier, a user role, or a network connectivity status;
inferring an intent for the first and second communications using artificial intelligence based on the context, the inferring based on a historical transaction pattern analysis, a predefined heuristic-based conflict resolution rule, or a user behavior prediction model;
selecting a conflict resolution module from a plurality of conflict resolution modules based on the inferred intent;
generating a resolved data structure by executing the selected conflict resolution module, in which, the resolved data structure is an updated version of the common data structure;
updating a local database of the local hub synchronization system with the resolved data structure.

19. The method as described in claim 18, further comprising propagating the resolved transaction update to the first and second edge devices to maintain data consistency.

20. The method as described in claim 18, further comprising synchronizing the resolved transaction update with a remote hub synchronization system responsive to detecting that network connectivity is available.
